(19) United States
(12) Patent Application Publication
(10) Pub. No.: US 2023/0139355 A1
(43) Pub. Date: May 4, 2023

(54) ADVERTISEMENT EVALUATION DEVICE, SYSTEM, METHOD, AND NON-TRANSITORY COMPUTER-READABLE MEDIUM STORING PROGRAM

(71) Applicant: NEC Corporation, Minato-ku, Tokyo (JP)

(72) Inventor: Honami YUKI, Tokyo (JP)

(73) Assignee: NEC Corporation, Minato-ku, Tokyo (JP)

(21) Appl. No.: 17/912,097

(22) PCT Filed: Mar. 30, 2020
(86) PCT No.: PCT/JP2020/014616

§ 371 Date: Sep. 16, 2022

(51) Int. Cl. G06Q 30/0242; G06Q 20/40

(52) U.S. Cl. CPC G06Q 30/0246; G06Q 20/40145

(57) ABSTRACT

An advertisement evaluation device includes: a first acquisition unit configured to acquire a first time in a case where first face authentication has succeeded for a first captured image obtained by imaging a predetermined user when the user enters a predetermined store; a second acquisition unit configured to acquire a second time in a case where second face authentication has succeeded for a second captured image obtained by imaging the user when the payment is made in the store; a registration unit configured to register a payment history based on the payment in association with the user; a calculation unit configured to calculate a stay time of the user in the store; and an evaluation unit configured to evaluate an advertising effectiveness of advertisement information presented to the user based on the payment history and the stay time.

### TECHNICAL FIELD

The present invention relates to an advertisement evaluation device, a system, a method, and a non-transitory computer-readable medium storing a program, and more particularly, to an advertisement evaluation device, a system, a method, and a non-transitory computer-readable medium storing a program for evaluating an advertisement presented to a user.

### BACKGROUND ART

Patent Literature 1 discloses a technology of providing advertisement information regarding a predetermined store based on location information of a user and evaluating an advertising effectiveness of the advertisement information provided to the user based on a stay time of the user in the store.

### CITATION LIST

### Patent Literature

Patent Literature 1: Japanese Unexamined Patent Application Publication No. 2019-149098

### SUMMARY OF INVENTION

### Technical Problem

However, a long stay time in a store does not necessarily lead to the profit of the store. Therefore, the technology according to Patent Literature 1 has a problem that evaluation of the advertising effectiveness is insufficient.

The present disclosure has been made to solve such a problem, and an object of the present disclosure is to provide an advertisement evaluation device, a system, a method, and a non-transitory computer-readable medium storing a program for accurately measuring an effect of an advertisement presented to a user.

### Solution to Problem

An advertisement evaluation device according to the present disclosure includes: a first acquisition unit configured to acquire a first time that is an entrance time to a predetermined store in a case where first face authentication using an authentication device that stores face feature information of the user in advance has succeeded for a first captured image obtained by imaging the user when the user enters the store; a second acquisition unit configured to acquire a second time that is a payment time in a case where second face authentication using the authentication device has succeeded for a second captured image obtained by imaging the user when the user makes payment in the store; a registration unit configured to register a payment history based on the payment in association with the user in a case where the second face authentication has succeeded; a calculation unit configured to calculate a stay time of the user in the store based on a difference between the first time and the second time; and an evaluation unit configured to evaluate an advertising effectiveness of advertisement information presented to the user based on the payment history and the stay time.

An advertisement evaluation device according to the present disclosure includes: a calculation unit configured to calculate a stay time of a user in a store; and an evaluation unit configured to evaluate an advertising effectiveness of advertisement information presented to the user based on the stay time.

An advertisement evaluation system according to the present disclosure includes: an imaging device configured to capture an image including a face region of a predetermined user; a payment terminal configured to perform payment for the user; an advertisement evaluation device configured to be communicable with the imaging device and the payment terminal; and an authentication device configured to store face feature information of the user and be communicable with the advertisement evaluation device, in which the advertisement evaluation device includes: a first acquisition unit configured to acquire a first time that is an entrance time to a predetermined store in a case where first face authentication using an authentication device that stores face feature information of the user in advance has succeeded for a first captured image obtained by imaging the user when the user enters the store; a second acquisition unit configured to acquire a second time that is a payment time in a case where second face authentication using the authentication device has succeeded for a second captured image obtained by imaging the user when the user makes payment in the store; a registration unit configured to register a payment history based on the payment in association with the user in a case where the second face authentication has succeeded; a calculation unit configured to calculate a stay time of the user in the store based on a difference between the first time and the second time; and an evaluation unit configured to evaluate an advertising effectiveness of advertisement information presented to the user based on the payment history and the stay time.

An advertisement evaluation method according to the present disclosure performed by a computer includes: acquiring a first time that is an entrance time to a predetermined store in a case where first face authentication using an authentication device that stores face feature information of a predetermined user in advance has succeeded for a first captured image obtained by imaging the user when the user enters the store; acquiring a second time that is a payment time in a case where second face authentication using the authentication device has succeeded for a second captured image obtained by imaging the user when the user makes payment in the store; registering a payment history based on the payment in association with the user in a case where the second face authentication has succeeded; calculating a stay time of the user in the store based on a difference between the first time and the second time; and evaluating an advertising effectiveness of advertisement information presented to the user based on the payment history and the stay time.

A non-transitory computer-readable medium according to the present disclosure stores a program for performing: acquiring a first time that is an entrance time to a predetermined store in a case where first face authentication using an authentication device that stores face feature information of a predetermined user in advance has succeeded for a first captured image obtained by imaging the user when the user enters the store; acquiring a second time that is a payment time in a case where second face authentication using the authentication device has succeeded for a second captured image obtained by imaging the user when the user makes payment in the store; registering a payment history based on the payment in association with the user in a case where the second face authentication has succeeded; calculating a stay time of the user in the store based on a difference between the first time and the second time; and evaluating an advertising effectiveness of advertisement information presented to the user based on the payment history and the stay time.

An advertisement evaluation device according to the present disclosure includes: a first authentication unit configured to perform first face authentication by using face feature information of a predetermined user stored in advance for a first captured image obtained by imaging the user when the user enters a predetermined store; a first acquisition unit configured to acquire a first time that is an entrance time to the store in a case where the first face authentication has succeeded for the first captured image obtained by imaging the user when the user enters the store; a second authentication unit configured to perform second face authentication by using the face feature information of the user for a second captured image obtained by imaging the user when the user makes payment in the store; a second acquisition unit configured to acquire a second time that is a payment time in a case where the second face authentication has succeeded for the second captured image obtained by imaging the user when the user makes the payment in the store; a registration unit configured to register a payment history based on the payment in association with the user in a case where the second face authentication has succeeded; a calculation unit configured to calculate a stay time of the user in the store based on a difference between the first time and the second time; and an evaluation unit configured to evaluate an advertising effectiveness of advertisement information presented to the user based on the payment history and the stay time.

An advertisement evaluation method according to the present disclosure performed by a computer includes: performing first face authentication by using face feature information of a predetermined user stored in advance for a first captured image obtained by imaging the user when the user enters a predetermined store; acquiring a first time that is an entrance time to the store in a case where the first face authentication has succeeded for the first captured image obtained by imaging the user when the user enters the store; performing second face authentication by using the face feature information of the user for a second captured image obtained by imaging the user when the user makes payment in the store; acquiring a second time that is a payment time in a case where the second face authentication has succeeded for the second captured image obtained by imaging the user when the user makes the payment in the store; registering a payment history based on the payment in association with the user in a case where the second face authentication has succeeded; calculating a stay time of the user in the store based on a difference between the first time and the second time; and evaluating an advertising effectiveness of advertisement information presented to the user based on the payment history and the stay time.

A non-transitory computer-readable medium according to the present disclosure stores a program for performing: performing first face authentication by using face feature information of a predetermined user stored in advance for a first captured image obtained by imaging the user when the user enters a predetermined store; acquiring a first time that is an entrance time to the store in a case where the first face authentication has succeeded for the first captured image obtained by imaging the user when the user enters the store; performing second face authentication by using the face feature information of the user for a second captured image obtained by imaging the user when the user makes payment in the store; acquiring a second time that is a payment time in a case where the second face authentication has succeeded for the second captured image obtained by imaging the user when the user makes the payment in the store; registering a payment history based on the payment in association with the user in a case where the second face authentication has succeeded; calculating a stay time of the user in the store based on a difference between the first time and the second time; and evaluating an advertising effectiveness of advertisement information presented to the user based on the payment history and the stay time.

### Advantageous Effects of Invention

According to the present disclosure, it is possible to provide the advertisement evaluation device, the system, the method, and the non-transitory computer-readable medium storing the program for accurately measuring an effect of an advertisement presented to a user.

### BRIEF DESCRIPTION OF DRAWINGS

FIG. 1 is a block diagram illustrating a configuration of an advertisement evaluation device according to a first example embodiment.

FIG. 2 is a flowchart illustrating a flow of an advertisement evaluation method according to the first example embodiment.

FIG. 3 is a block diagram illustrating a configuration of an advertisement evaluation device according to a second example embodiment.

FIG. 4 is a flowchart illustrating a flow of an advertisement evaluation method according to the second example embodiment.

FIG. 5 is a block diagram illustrating a configuration of an advertisement evaluation system according to a third example embodiment.

FIG. 6 is a block diagram illustrating a configuration of an authentication device.

FIG. 7 is a flowchart illustrating a flow of face feature information registration processing.

FIG. 8 is a flowchart illustrating a flow of face authentication processing.

FIG. 9 is a block diagram illustrating a configuration of a payment terminal.

FIG. 10 is a block diagram illustrating a configuration of a user terminal.

FIG. 11 is a block diagram illustrating a configuration of an advertisement evaluation device.

FIG. 12 is a flowchart illustrating a flow of advertisement evaluation processing.

FIG. 13 is a flowchart illustrating a flow of store entrance time acquisition processing.

FIG. 14 is a flowchart illustrating a flow of payment time acquisition processing.

FIG. 15 is a view illustrating an advertisement information screen displayed on a display terminal.

FIG. 16 is a view illustrating a map displayed on the display terminal.

FIG. 17 is a view illustrating an action history displayed on the display terminal.

FIG. 18 is a block diagram illustrating a configuration of an advertisement evaluation system according to a fourth example embodiment.

FIG. 19 is a block diagram illustrating a configuration of an advertisement evaluation device according to the fourth example embodiment.

FIG. 20 is a flowchart illustrating a flow of advertisement evaluation processing.

FIG. 21 is a flowchart illustrating the flow of the advertisement evaluation processing.

FIG. 22 is a flowchart illustrating a flow of store entrance time acquisition processing.

FIG. 23 is a flowchart illustrating a flow of stay time calculation processing.

### EXAMPLE EMBODIMENT

Hereinafter, example embodiments of the present disclosure will be described in detail with reference to the drawings. In the drawings, the same or corresponding elements are denoted by the same reference signs, and an overlapping description is omitted as necessary for clarity of description.

### First Example Embodiment

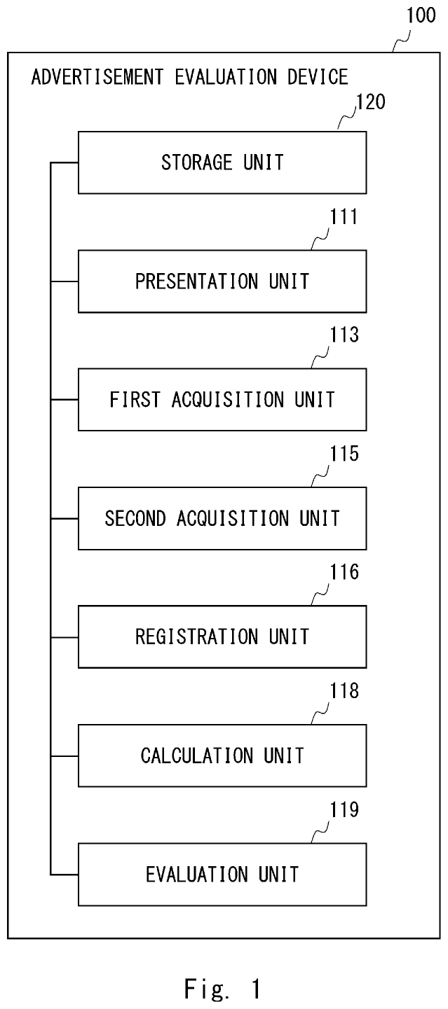

FIG. 1 is a block diagram illustrating a configuration of an advertisement evaluation device 100 according to a first example embodiment. The advertisement evaluation device 100 includes a storage unit 120, a presentation unit 111, a first acquisition unit 113, a second acquisition unit 115, a registration unit 116, a calculation unit 118, and an evaluation unit 119. The advertisement evaluation device 100 is connected to a network 500 (not illustrated). The network 500 may be a wired network or a wireless network. An authentication device 200, an imaging device, a payment terminal 400, a user terminal 1200, and the like (not illustrated) are connected to the network 500.

The storage unit 120 stores a predetermined user and advertisement information of a predetermined store in association with each other. The presentation unit 111 presents advertisement information associated with a predetermined user to the user. In a case where first face authentication using the authentication device 200 that stores face feature information of a predetermined user in advance has succeeded for a first captured image obtained by imaging the user when the user enters a predetermined store, the first acquisition unit 113 acquires a first time that is an entrance time to the store. In a case where second face authentication using the authentication device 200 has succeeded for a second captured image obtained by imaging the user when the user makes payment in the store, the second acquisition unit 115 acquires a second time that is a payment time.

Once the second face authentication has succeeded, the registration unit 116 registers, in the storage unit 120, a payment history based on the payment in association with the user. The calculation unit 118 calculates a stay time of the user in the store based on a difference between the first time and the second time. The evaluation unit 119 evaluates an advertising effectiveness of the presented advertisement information based on the payment history and the stay time.

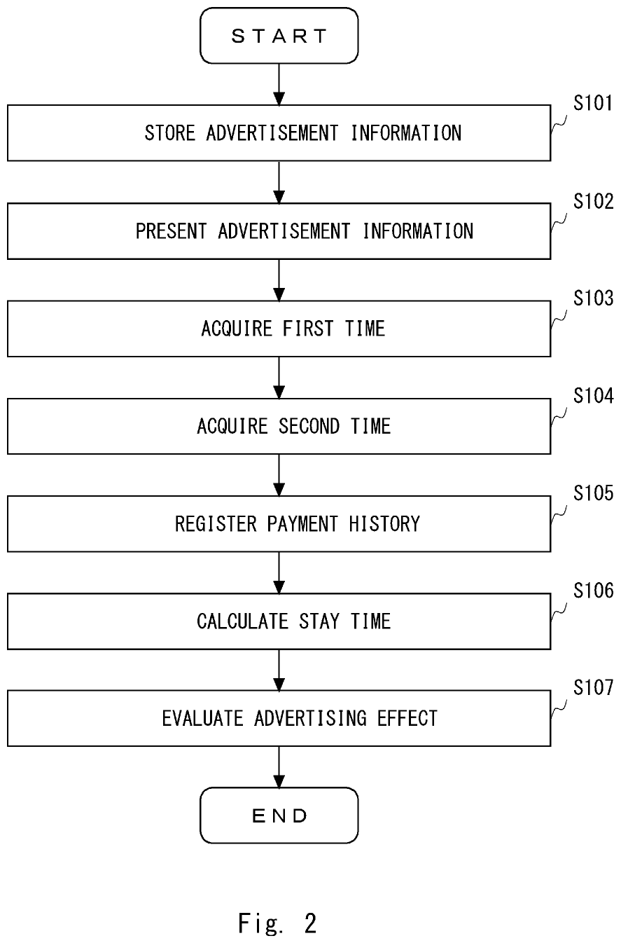

FIG. 2 is a flowchart illustrating a flow of an advertisement evaluation method according to the first example embodiment. First, the storage unit 120 stores a predetermined user and advertisement information of a predetermined store in association with each other (Step S101). Next, the presentation unit 111 presents the advertisement information associated with the predetermined user to the user (Step S102). Next, in a case where the first face authentication using the authentication device 200 that stores face feature information of the predetermined user in advance has succeeded for the first captured image obtained by imaging the user when the user enters the store, the first acquisition unit 113 acquires the first time, which is an entrance time to the store (Step S103). Note that, before Step S103, the authentication device 200 collates face feature information included in the first captured image with the face feature information registered in the authentication device 200, and performs the first face authentication for determining whether or not the authentication is successful based on whether or not the pieces of face feature information match each other. In a case where the first face authentication has succeeded, the authentication device 200 includes, in the determination result, a user ID for which the authentication has succeeded, and transmits the determination result as a response to the advertisement evaluation device 100.

Next, in a case where the second face authentication using the authentication device 200 has succeeded for the second captured image obtained by imaging the predetermined user when the user makes payment in the store, the second acquisition unit 115 acquires the second time, which is the payment time (Step S104). Note that, before Step S104, the authentication device 200 collates face feature information included in the second captured image with the face feature information registered in the authentication device 200, and performs the second face authentication for determining whether or not the authentication is successful based on whether or not the pieces of face feature information match each other. In a case where the second face authentication has succeeded, the authentication device 200 includes, in the determination result, a user ID for which the authentication has succeeded, and transmits the determination result as a response to the advertisement evaluation device 100.

Next, once the second face authentication has succeeded, the registration unit 116 registers, in the storage unit 120, a payment history based on the payment in association with the user (Step S105). Next, the calculation unit 118 calculates a stay time of the user in the store based on a difference between the first time and the second time (Step S106). Next, the evaluation unit 119 evaluates an advertising effectiveness of the presented advertisement information based on the payment history and the stay time (Step S107). Since the advertisement evaluation method according to the present example embodiment can evaluate an advertising effectiveness of presented advertisement information based on a payment history of a user and a stay time in a store as described above, it is possible to accurately measure the descent of an advertisement recommended to the user.

Note that the advertisement evaluation device 100 includes a processor, a memory, and a storage device as components not illustrated. Furthermore, the storage device stores a computer program in which processing of the advertisement evaluation method according to the present example embodiment is implemented. Then, the processor reads the computer program from the storage device into the memory, and executes the computer program. As a result, the processor implements the functions of a history registration unit, the presentation unit 111, the first acquisition unit 113, the second acquisition unit 115, the registration unit 116, the calculation unit 118, and the evaluation unit 119.

Alternatively, each of the history registration unit, the presentation unit 111, the first acquisition unit 113, the second acquisition unit 115, the registration unit 116, the calculation unit 118, and the evaluation unit 119 may be implemented by dedicated hardware. In addition, some or all of the components of each device may be implemented by a general-purpose or dedicated circuitry, a processor, or the like, or a combination thereof. These may be implemented by a single chip or may be implemented by a plurality of chips connected via a bus. Some or all of the components of each device may be implemented by a combination of the above-described circuit or the like and a program. Furthermore, a central processing unit (CPU), a graphics processing unit (GPU), a field-programmable gate array (FPGA), or the like can be used as the processor.

Furthermore, in a case where some or all of the components of the advertisement evaluation device 100 are implemented by a plurality of information processing devices, circuits, and the like, the plurality of information processing devices, circuits, and the like may be arranged in a centralized manner or in a distributed manner. For example, the information processing devices, the circuits, and the like may be implemented in a form in which each of them is connected via a communication network, such as a client server system or a cloud computing system. Furthermore, the function of the advertisement evaluation device 100 may be provided in a software as a service (SaaS) format.

### Second Example Embodiment

A second example embodiment is a modification of the first example embodiment described above. The advertisement evaluation device 100 according to the first example embodiment performs face authentication by using the external authentication device 200. On the other hand, an advertisement evaluation device 600 according to the present example embodiment performs face authentication inside the advertisement evaluation device 600.

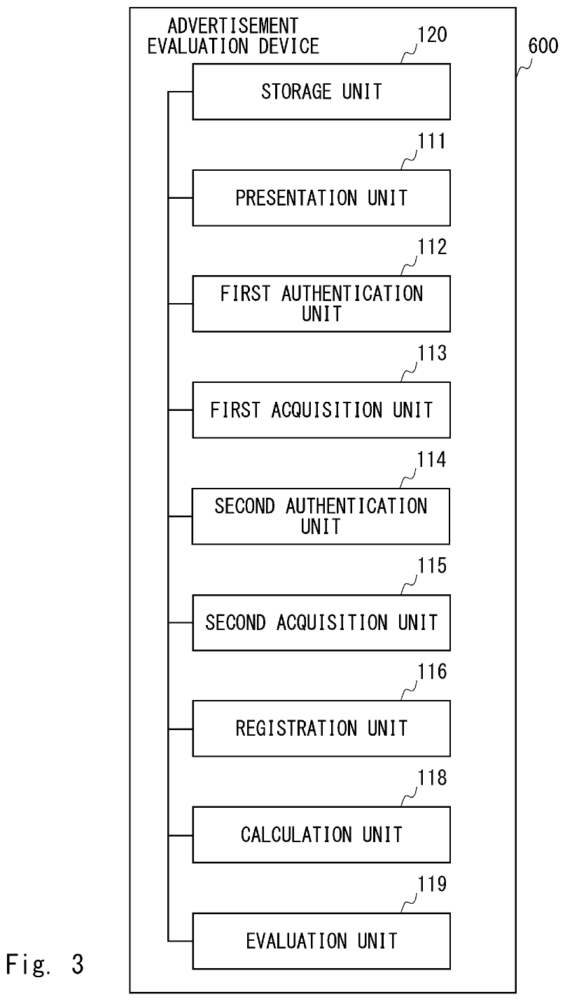

FIG. 3 is a block diagram illustrating a configuration of the advertisement evaluation device 600 according to the second example embodiment. The advertisement evaluation device 600 further includes a first authentication unit 112, a second authentication unit 114, and a face feature database (DB) (not illustrated) in addition to the components of the advertisement evaluation device 100 illustrated in FIG. 1. The face feature DB is a database that stores a user ID and face feature information in association with each other. For each component included in the advertisement evaluation device 600, a description overlapping with that of the first example embodiment will be omitted as appropriate.

The first authentication unit 112 performs first face authentication on a first captured image obtained by imaging a predetermined user when the user enters a store by using face feature information of the user stored in advance. In the first face authentication, the first authentication unit 112 extracts face feature information from the first captured image, collates the face feature information with the face feature information stored in the face feature DB, and determines whether or not the authentication is successful based on whether or not the pieces of face feature information match each other. The face feature DB stores face feature information of a plurality of registered users. The first authentication unit 112 outputs a result indicating the success or failure of the first face authentication to the first acquisition unit 113. In a case where the first face authentication has succeeded, the first acquisition unit 113 acquires a first time that is an entrance time of the user to the store.

The second authentication unit 114 performs second face authentication on a second captured image obtained by imaging the user when the user makes payment in the store by using the face feature information of the user stored in advance. In the second face authentication, the second authentication unit 114 extracts face feature information from the second captured image, collates the face feature information with the face feature information stored in the face feature DB, and determines whether or not the authentication is successful based on whether or not the pieces of face feature information match each other. The second authentication unit 114 outputs a result indicating the success or failure of the second face authentication to the second acquisition unit 115. In a case where the second face authentication has succeeded, the second acquisition unit 115 acquires a second time that is a payment time of the user.

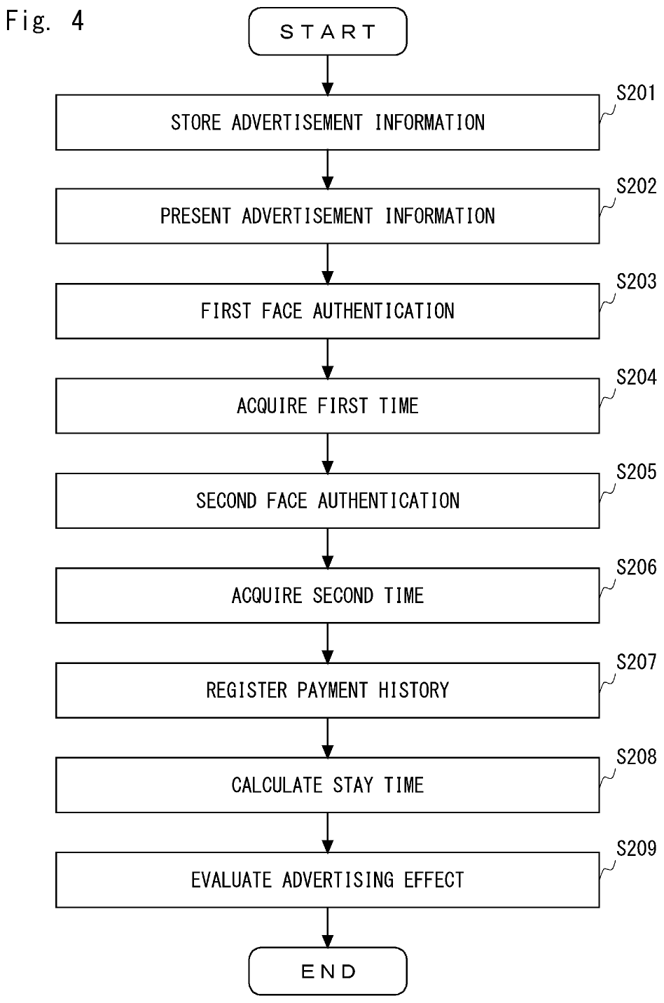

FIG. 4 is a flowchart illustrating a flow of an advertisement evaluation method according to the second example embodiment. First, the storage unit 120 stores a predetermined user and advertisement information of a predetermined store in association with each other (Step S201). Next, the presentation unit 111 presents the advertisement information associated with the predetermined user to the user (Step S202). Next, the first authentication unit 112 performs the first face authentication on the first captured image obtained by imaging the predetermined user when the user enters the store by using face feature information of the predetermined user stored in advance (Step S203). In a case where the first face authentication has succeeded for the first captured image obtained by imaging the predetermined user when the user enters the store, the first acquisition unit 113 acquires the first time, which is the entrance time to the store (Step S204).

Next, the second authentication unit 114 performs the second face authentication on the second captured image obtained by imaging the predetermined user when the user makes payment in the store by using the face feature information of the predetermined user stored in advance (Step S205). Next, in a case where the second face authentication has succeeded for the second captured image obtained by imaging the predetermined user when the user makes payment in the store, the second acquisition unit 115 acquires the second time, which is the payment time (Step S206).

Next, once the second face authentication has succeeded, the registration unit 116 registers, in the storage unit 120, a payment history based on the payment in association with the user (Step S207). Next, the calculation unit 118 calculates a stay time of the user in the store based on a difference between the first time and the second time (Step S208). Next, the evaluation unit 119 evaluates an advertising effectiveness of the presented advertisement information based on the payment history and the stay time (Step S209). Furthermore, the advertisement evaluation device according to the present example embodiment can achieve effects similar to the effects described in the first example embodiment.

### Third Example Embodiment

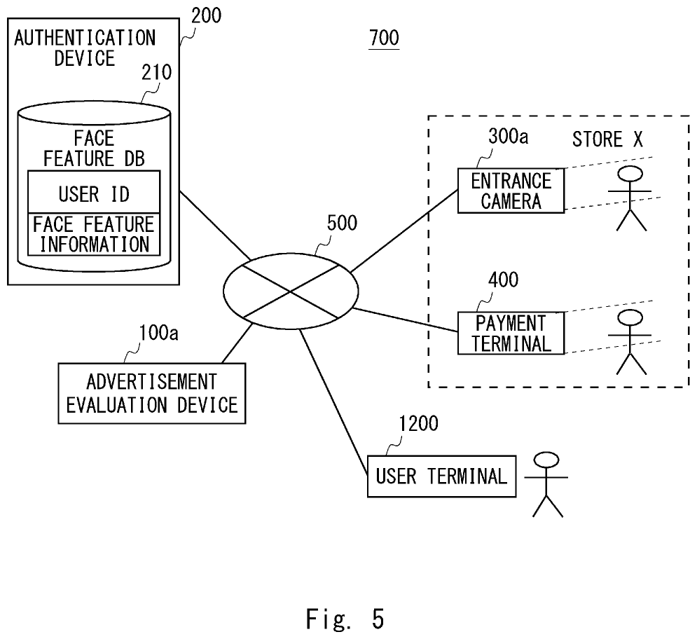

A third example embodiment is a specific example of the first example embodiment described above. FIG. 5 is a block diagram illustrating a configuration of an advertisement evaluation system 700 according to the third example embodiment. The advertisement evaluation system 700 includes an advertisement evaluation device 100a, an authentication device 200, an entrance camera 300a, a payment terminal 400, and a user terminal 1200. Each of the advertisement evaluation device 100a, the authentication device 200, the entrance camera 300a, the payment terminal 400, and the user terminal 1200 is connected via a network 500. Note that a description overlapping with the first example embodiment will be omitted as appropriate.

The advertisement evaluation device 100a is an information processing device that presents advertisement information in response to an advertisement request and evaluates an advertising effectiveness of the presented advertisement information, and is, for example, a server device implemented by a computer. The authentication device 200 is a device that performs first face authentication and second face authentication. The authentication device 200 includes a face feature DB 210. The face feature DB 210 is a face feature database that stores a user ID and face feature information of a corresponding user in association with each other. Note that the face feature DB 210 is an example of a face feature information storage unit.

The advertisement evaluation device 100a outputs advertisement information to a display terminal. The display terminal is, for example, the user terminal 1200, the payment terminal 400, a signage, or the like. A user terminal 1200 is a communication terminal such as a smartphone carried by a user. The signage is a terminal installed on a street or the like, and displays, for example, “how about visiting ∘∘ next?” or the like when a user stands in front of the signage.

The entrance camera 300a and the payment terminal 400 are installed in the store X. The entrance camera 300a is a terminal that captures a first captured image. Note that the entrance camera 300a is an example of an imaging device. The entrance camera 300a is, for example, a digital camera installed near the entrance of the store X, a digital signage equipped with a camera, or a face authentication terminal. The entrance camera 300a captures the first captured image by imaging a user who has entered the store X. The entrance camera 300a transmits the first captured image to the advertisement evaluation device 100a via the network 500.

Note that, in a case where the advertisement evaluation system 700 is installed in a facility having a plurality of floors, entrance and payment made by a user may be recorded for each floor. In this case, the entrance camera 300a is installed near an entrance of each floor. The entrance of each floor is, for example, an exit of an escalator, an exit of an elevator, and an exit of a staircase. The entrance camera 300a captures the first captured image by imaging a user who has entered the floor.

The payment terminal 400 is an information processing device for performing payment when a user who has entered the store X makes a purchase in the store X. In addition, the payment terminal 400 captures an image including a face of a user who has made payment at the time of the payment as a second captured image, and transmits the second captured image to the advertisement evaluation device 100a via the network 500. For example, the payment terminal 400 may perform payment once the face authentication has succeeded. Specifically, the payment terminal 400 receives a face authentication result from the advertisement evaluation device 100a, performs payment processing in a case where the face authentication has succeeded, and transmits a payment history to the advertisement evaluation device 100a via the network 500. The payment history includes, for example, a date and time of payment, a payment amount, a payment content, and the like. The payment content is, for example, a purchased item and a purchased service.

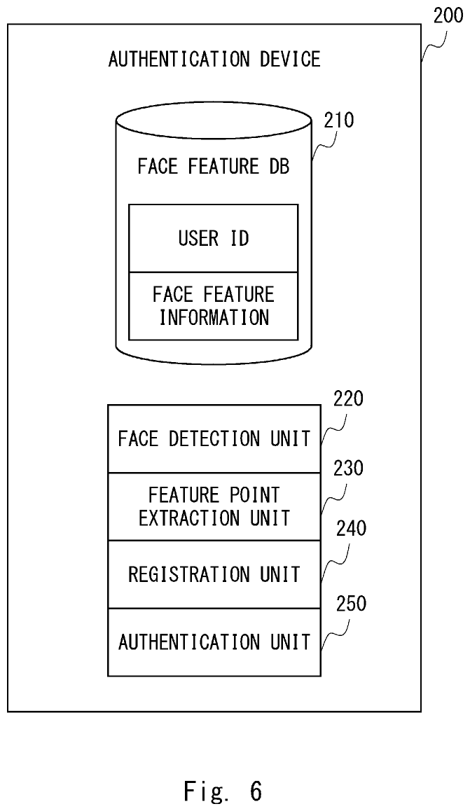

Next, a configuration of the authentication device 200 will be described in detail with reference to FIG. 6. FIG. 6 is a block diagram illustrating a configuration of the authentication device 200. The authentication device 200 includes the face feature DB 210, a face detection unit 220, a feature point extraction unit 230, a registration unit 240, and an authentication unit 250.

The face feature DB 210 is a face feature database that stores a user ID and face feature information of a corresponding user in association with each other. The face detection unit 220 detects a face region included in a captured image and outputs the face region to the feature point extraction unit 230. The feature point extraction unit 230 extracts a feature point from the face region detected by the face detection unit 220, and outputs face feature information to the registration unit 240. The face feature information is a set of extracted feature points.

The registration unit 240 newly issues a user ID when registering the face feature information. The registration unit 240 registers the issued user ID and the face feature information extracted from the registered image in association with each other in the face feature DB 210. The authentication unit 250 collates face feature information extracted from a face image with the face feature information in the face feature DB 210. The authentication unit 250 determines that the face authentication has succeeded in a case where the pieces of face feature information match each other, and determines that the face authentication has failed in a case where the pieces of face feature information do not match each other. The authentication unit 250 transmits a result indicating the success or failure of the face authentication as a response to the advertisement evaluation device 100a. Whether or not the pieces of face feature information match each other corresponds to the success or failure of the authentication. In addition, in a case where the face authentication has succeeded, the authentication unit 250 specifies a user ID associated with the face feature information for which the authentication has succeeded, and transmits an authentication result including the specified user ID and the fact that the authentication has succeeded to the advertisement evaluation device 100a.

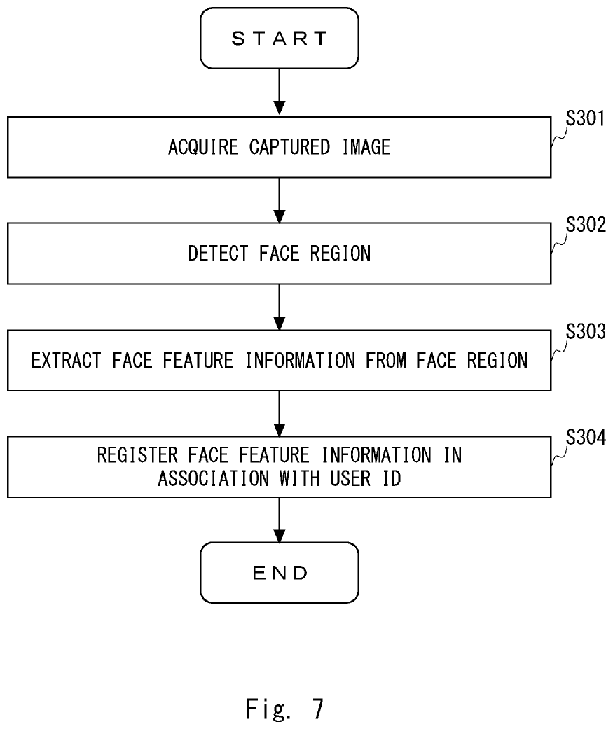

An operation of the authentication device 200 when registering a user ID and face feature information in the face feature DB 210 will be described with reference to FIG. 7. FIG. 7 is a flowchart illustrating a flow of face feature information registration processing.

When registering face feature information, a face information registration terminal (not illustrated) captures an image including a face of a user as a registration image, and transmits a face feature information registration request to the authentication device 200 via the network 500. The face information registration terminal is, for example, an information processing device such as a personal computer, a smartphone, or a tablet terminal. The face feature information registration request includes the registration image. First, the authentication device 200 acquires the registration image included in the face feature information registration request from the face information registration terminal via the network 500 (Step S301).

Next, the face detection unit 220 detects a face region included in the registration image (Step S302), and outputs the detected face region to the feature point extraction unit 230. Next, the feature point extraction unit 230 extracts a feature point from the face region and outputs face feature information to the registration unit 240 (Step S303). Next, the registration unit 240 issues a user ID corresponding to the output face feature information, and registers the user ID and the face feature information in association with each other in the face feature DB 210 (Step S304).

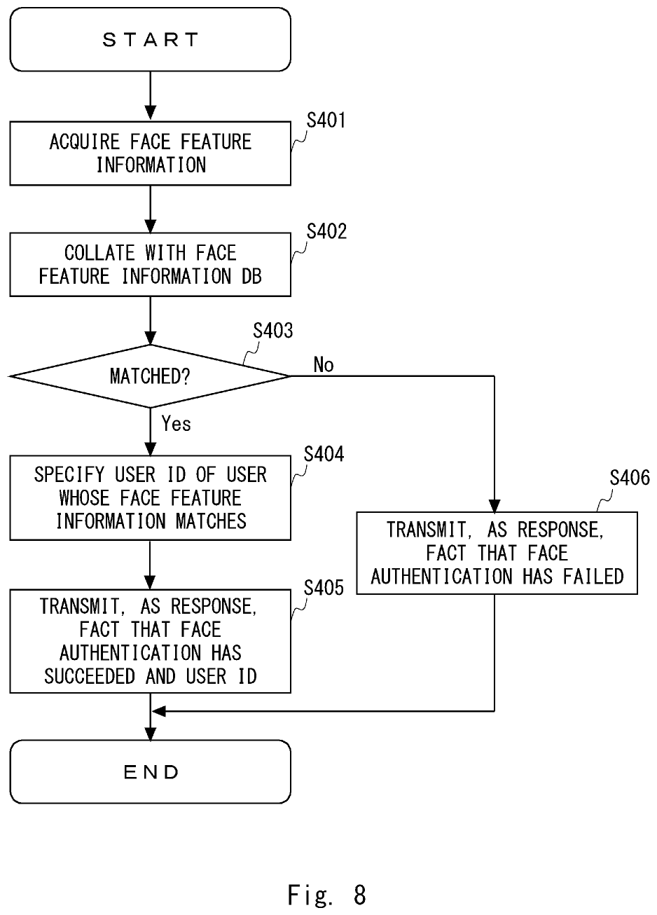

An operation of the authentication device 200 when performing the face authentication will be described with reference to FIG. 8. FIG. 8 is a flowchart illustrating a flow of face authentication processing. A case where the first face authentication is performed will be described in FIG. 8. However, the face authentication can be performed in a similar procedure also in a case where the second face authentication is performed.

Once a user enters the store X, the entrance camera 300a captures an image including a face of the user as the first captured image, and transmits the first captured image to the advertisement evaluation device 100a via the network 500. The advertisement evaluation device 100a extracts a face region or face feature information from the first captured image. The advertisement evaluation device 100a transmits the extracted face region or face feature information to the authentication device 200. The feature point extraction unit 230 acquires the face feature information by extracting the face feature information from the received face region or by receiving the face feature information (Step S401).

Next, the authentication unit 250 collates the acquired face feature information with that in the face feature DB 210 (Step S402). In a case where the pieces of face feature information match each other (Yes in Step S403), the authentication unit 250 specifies a user ID of the user whose face feature information matches (Step S404), and transmits, as a response, the fact that the face authentication has succeeded and the specified user ID to the advertisement evaluation device 100a (Step S405). In a case where there is no face feature information that matches with the acquired face feature information (No in Step S403), the authentication unit 250 transmits, as a response, the fact that the face authentication has failed to the advertisement evaluation device 100a (Step 4306).

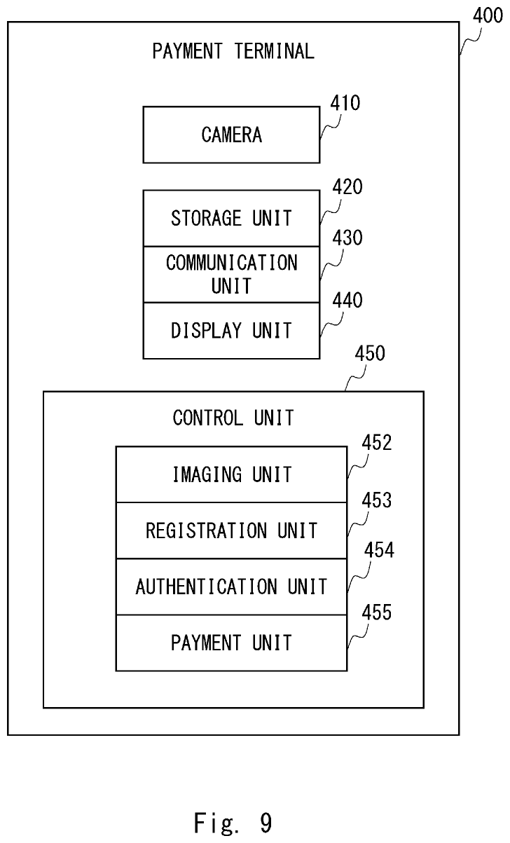

Next, a configuration of the payment terminal 400 will be described in detail with reference to FIG. 9. The payment terminal 400 includes an imaging device such as a camera, a display device, and a computer as hardware components. The payment terminal 400 is a device that performs capturing of the second captured image and payment processing.

FIG. 9 is a block diagram illustrating a configuration of the payment terminal 400. The payment terminal 400 includes a camera 410, a storage unit 420, a communication unit 430, a display unit 440, and a control unit 450. The camera 410 is an imaging device that captures an image. The storage unit 420 is a storage device that stores a program for implementing each function of the payment terminal 400. The communication unit 430 is a communication interface with the network 500. The display unit 440 is a display device that displays a face authentication result, advertisement information, and the like to a user.

The control unit 450 controls hardware included in the payment terminal 400. The control unit 450 includes an imaging unit 452, a registration unit 453, an authentication unit 454, and a payment unit 455.

The imaging unit 452 transmits an imaging request to the camera 410. The camera 410 captures an image including a face of a user. The image captured by the camera 410 is used as the second captured image. The registration unit 453 transmits a history registration request to the advertisement evaluation device 100a via the network 500. Note that the history registration request includes a payment history that is a result of the payment processing. The payment history is, for example, information including a date and time of payment, the amount of money, an article, a user ID, and the like. The authentication unit 454 transmits a second face authentication request to the advertisement evaluation device 100a via the network 500, and receives the result from the advertisement evaluation device 100a. A result indicating the success or failure of the face authentication may be displayed on the display unit 440. The payment unit 455 performs the payment processing in a case where the face authentication has succeeded.

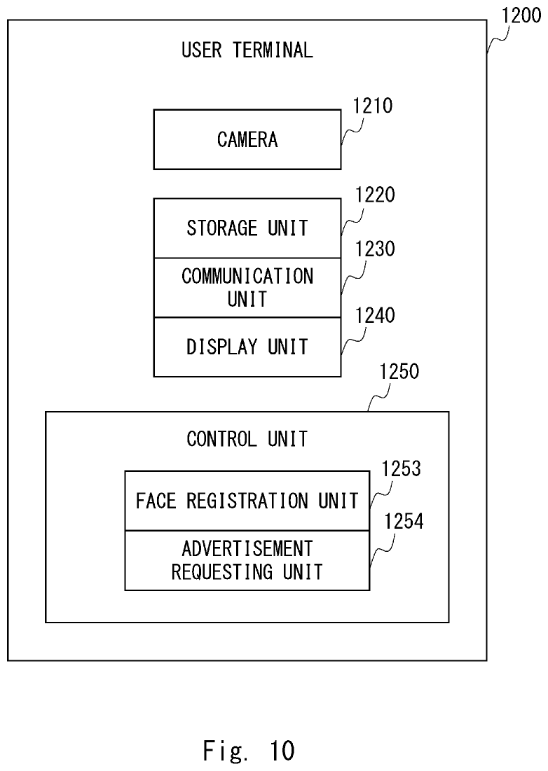

Next, a configuration of the user terminal 1200 will be described in detail with reference to FIG. 10. The user terminal 1200 includes an imaging device such as a camera, a display device, and a computer as hardware components. The user terminal 1200 is an information processing device operated by a predetermined user. The user terminal 1200 is a device that makes the face feature information registration request and the advertisement request.

FIG. 10 is a block diagram illustrating a configuration of the user terminal 1200. The user terminal 1200 includes a camera 1210, a storage unit 1220, a communication unit 1230, a display unit 1240, and a control unit 1250. The camera 1210 is an imaging device that captures an image. The storage unit 1220 is a storage device that stores a program for implementing each function of the user terminal 1200. The communication unit 1230 is a communication interface with the network 500. The display unit 1240 is a display device that displays a face registration result, advertisement information, and the like to a user. The control unit 1250 controls hardware included in the user terminal 1200. The control unit 1250 includes a face registration unit 1253 and an advertisement requesting unit 1254.

The face registration unit 1253 transmits an imaging request to the camera 1210. The camera 1210 captures an image including a face of a user. The image captured by the camera 1210 is used as the registration image. The face registration unit 1253 transmits the face feature information registration request to the advertisement evaluation device 100a via the network 500. Note that the face feature information registration request includes the registration image captured by the camera 1210 and a user ID. The advertisement requesting unit 1254 transmits the advertisement request to the advertisement evaluation device 100a via the network 500, and receives advertisement information as a result from the advertisement evaluation device 100a. The advertisement information is displayed on the display unit 1240, for example.

Note that, in a case where the entrance camera 300a is a face authentication terminal, the face authentication terminal performs face authentication for a user who has entered a store. In a case where the face authentication has succeeded, the face authentication terminal may transmit the advertisement request to the advertisement evaluation device 100a via the network 500, receive the advertisement information from the advertisement evaluation device 100a, and display the advertisement information on the display unit. At this time, the face authentication terminal may include, in the advertisement request, the user ID of the user whose face authentication has succeeded.

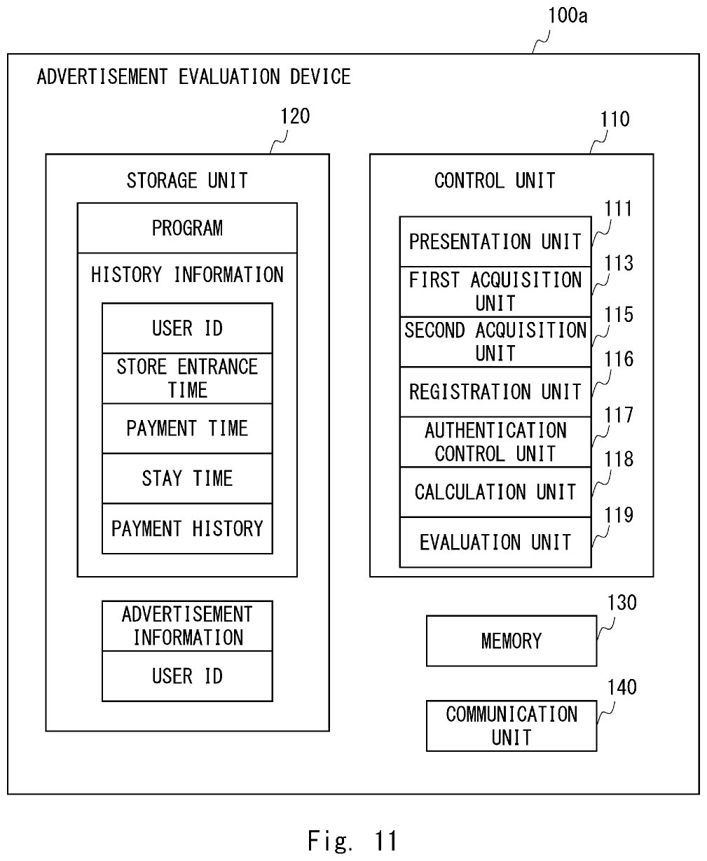

Next, a configuration of the advertisement evaluation device 100a will be described in detail with reference to FIG. 11. FIG. 11 is a block diagram illustrating a configuration of the advertisement evaluation device 100a. The advertisement evaluation device 100a includes a control unit 110, a storage unit 120, a memory 130, and a communication unit 140.

The storage unit 120 is a storage device that stores a program, history information, advertisement information, and a user ID. Note that the storage unit 120 includes a history storage unit. The program is a computer program in which the advertisement evaluation processing according to the present example embodiment is implemented. The history information is information in which a user ID, a store entrance time, a payment time, a stay time, and a payment history are associated with each other. Note that, in the present example embodiment, the payment time is regarded as a store leaving time. The user ID is information enabling identification of a user who has entered the store and is to make payment, and is, for example, a name, a telephone number, an e-mail address, an arbitrary identification number, or the like. The stay time is a difference between the payment time and the store entrance time. The payment history includes a date and time of payment, a payment amount, a payment content, and the like.

The advertisement information is associated with the user ID. The advertisement information is advertisement information of a predetermined store to be presented to the user. The advertisement information is, for example, introduction information of a store, a discount coupon of the store, or the like.

The memory 130 is a storage region for temporarily storing processing contents of the control unit 110, and is, for example, a volatile storage device such as a random access memory (RAM). The communication unit 140 is an interface that communicates with the outside of the advertisement evaluation device 100a.

The control unit 110 includes a presentation unit 111, a first acquisition unit 113, a second acquisition unit 115, a registration unit 116, an authentication control unit 117, a calculation unit 118, and an evaluation unit 119. The control unit 110 is a control device that controls the operation of the advertisement evaluation device 100a, and is, for example, a processor such as a CPU. The control unit 110 reads the program from the storage unit 120 into the memory 130 and executes the program. As a result, the control unit 110 implements the functions as the presentation unit 111, the first acquisition unit 113, the second acquisition unit 115, the registration unit 116, the authentication control unit 117, the calculation unit 118, and the evaluation unit 119.

Once the advertisement request is received, the presentation unit 111 specifies advertisement information associated with the user ID included in the advertisement request, and transmits, as a response, the specified advertisement information to the request source. In a case where the first face authentication using the authentication device 200 has succeeded for the first captured image, the first acquisition unit 113 acquires a first time. Note that the authentication device 200 stores face feature information of a plurality of registered users in advance in association with user IDs of the plurality of registered users. The first captured image is an image captured when a predetermined user enters a store, and includes a face region of the user. The first captured image is captured by the imaging device. The imaging device is, for example, the entrance camera 300a installed at an entrance of a store. The first time is a time at which a predetermined user enters the store, for example, a time at which the first captured image is captured.

In a case where the second face authentication using the authentication device 200 has succeeded for the second captured image, the second acquisition unit 115 acquires a second time. The second captured image is an image captured when the predetermined user makes payment in the store, and includes the face region of the user. The second captured image is captured by the camera included in the payment terminal 400. The second time is a time at which a predetermined user makes payment in the store.

The registration unit 116 registers a payment history in association with the user in the storage unit 120 once the second face authentication has succeeded. The payment history is a history of payment made when the second face authentication has succeeded. The authentication control unit 117 extracts a face region or face feature information from the first captured image and the second captured image, and transmits the face region or the face feature information to the authentication device 200 to control to perform face authentication. In addition, the authentication control unit 117 receives a result indicating the success or failure of the face authentication from the authentication device 200. Note that, in a case where the face authentication has succeeded, the user ID is included in the face authentication result. The calculation unit 118 calculates a stay time of a user in the store. The stay time is a difference between the first time and the second time.

The evaluation unit 119 evaluates an advertising effectiveness of the advertisement information based on the payment history and the stay time. First, the evaluation unit 119 acquires the payment history and the stay time of the user from the storage unit 120. Next, the evaluation unit 119 evaluates the advertising effectiveness for the combination of the payment history and the stay time. In a case where a plurality of payment histories of the user are registered in the storage unit 120, the advertising effectiveness is evaluated for each payment history.

For example, in a case where a payment amount of each of a plurality of payment histories is within a predetermined range, the evaluation unit 119 evaluates the advertising effectiveness based on a difference between stay times corresponding to the respective payment histories. In this case, in a case where the payment amount is within the predetermined range, the evaluation unit 119 evaluates the advertisement based on whether or not payment has been made without considering the payment amount. Specifically, the evaluation unit 119 evaluates that the advertising effectiveness is higher in a case where the stay time is short and a purchase history of a purchase for the payment amount less than a predetermined amount exists than in a case where the stay time is long and a purchase history of a purchase for the payment amount less than the predetermined amount exists. Furthermore, in a case where the payment amount is equal to or more than the predetermined value, the evaluation unit 119 may increase the advertising effectiveness according to the payment amount. Specifically, even in a case where the stay time is 10 minutes or more in Table 1 described later, the advertising effectiveness may be set to 5 in a case where the payment amount is equal to or more than the predetermined value. Note that the evaluation unit 119 may perform advertisement evaluation according to the payment amount without providing a predetermined range for the payment amount.

For example, in a case where a stay time corresponding to each of a plurality of payment histories is within a predetermined range, the evaluation unit 119 evaluates the advertising effectiveness based on a difference between payment amounts in the respective payment histories. Specifically, the evaluation unit 119 evaluates that the advertising effectiveness is higher in a case where the stay time is short and a purchase history exists than in a case where the stay time is short and no purchase history exists.

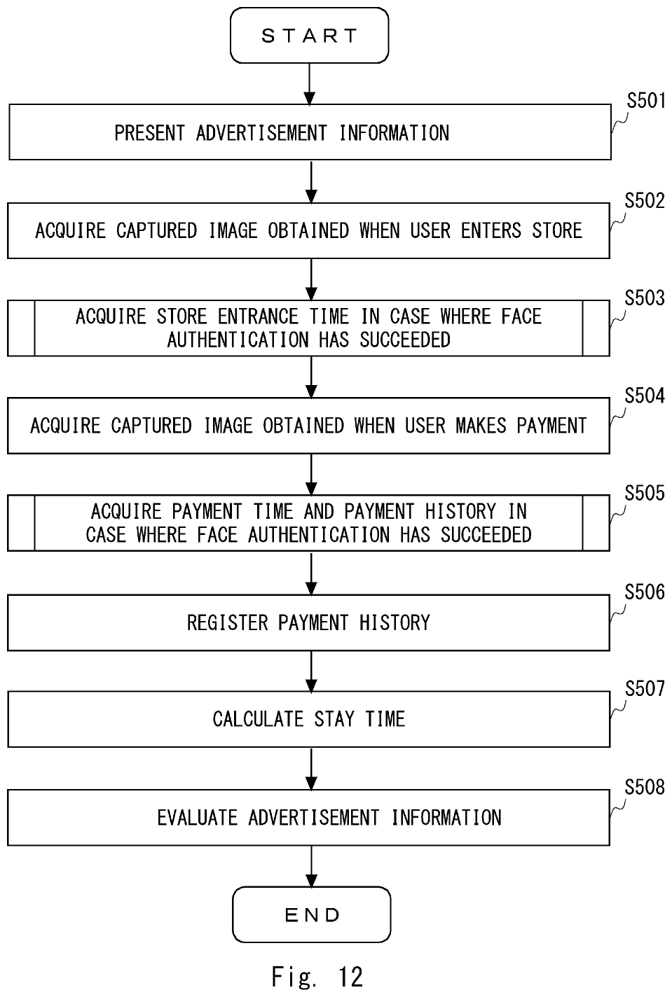

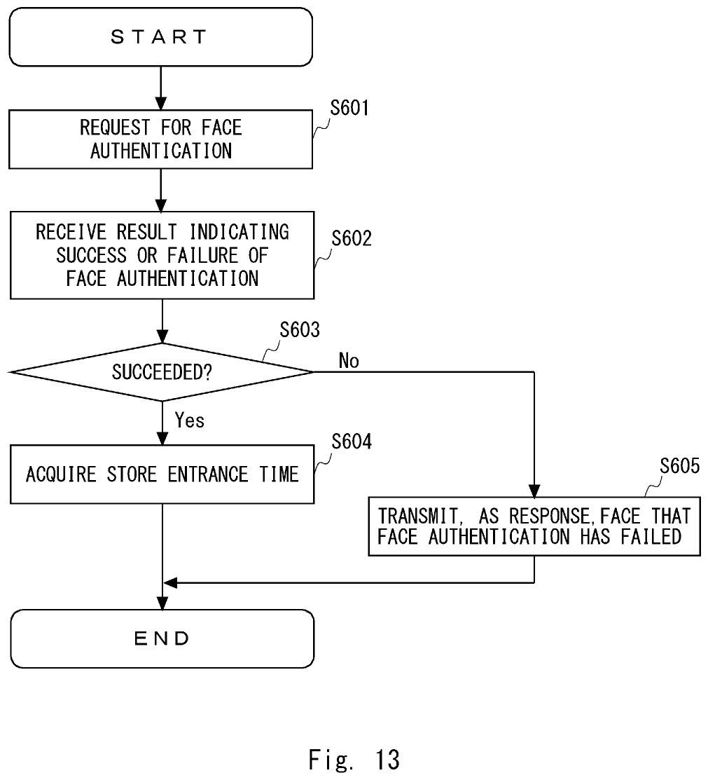

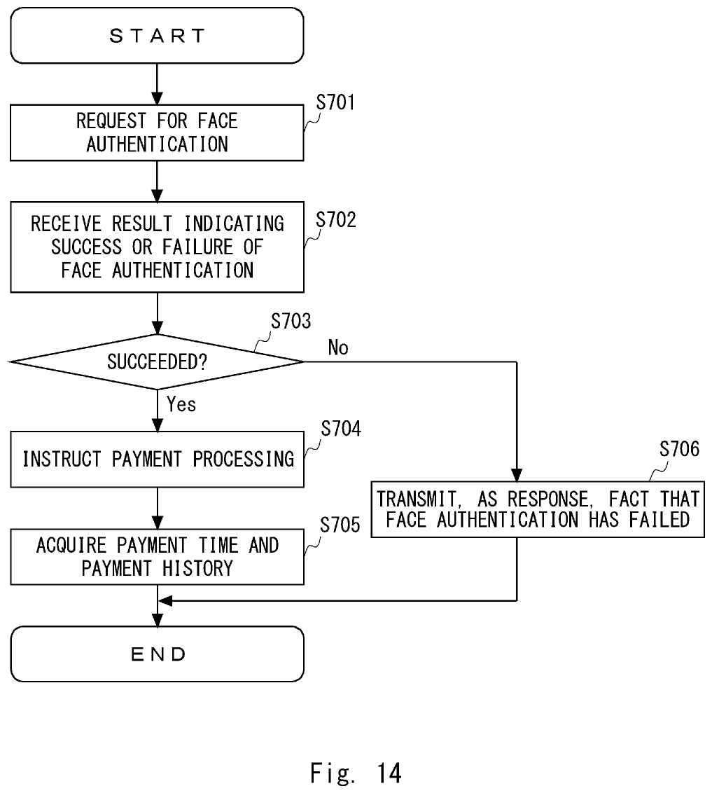

Next, an operation of the advertisement evaluation device 100a at the time of advertisement evaluation processing will be described with reference to FIGS. 12 to 14. FIG. 12 is a flowchart illustrating a flow of the advertisement evaluation processing. FIG. 13 is a flowchart illustrating a flow of store entrance time acquisition processing. FIG. 14 is a flowchart illustrating a flow of payment time acquisition processing.

First, the presentation unit 111 presents advertisement information associated with a user to the user by transmitting the advertisement information to a display terminal such as the user terminal 1200 (Step S501). Next, once the user enters the store X, the entrance camera 300a captures an image including a face of the user and transmits the captured image to the advertisement evaluation device 100a via the network 500. The authentication control unit 117 acquires the captured image (first captured image) obtained when the user enters the store by receiving the captured image from the entrance camera 300a (Step S502), and causes the authentication device 200 to perform the first face authentication. In a case where the first face authentication has succeeded, the first acquisition unit 113 acquires a store entrance time (first time) of the user (Step S503). Note that, in Step S503, the first acquisition unit 113 acquires an imaging time of the first captured image as the first time.

Next, the user makes payment in the store X. At the time of payment, the payment terminal 400 captures an image including the face of the user and transmits the captured image to the advertisement evaluation device 100a via the network 500. The authentication control unit 117 acquires the captured image (second captured image) obtained when the user makes payment by receiving the captured image from the payment terminal 400 (Step S504), and causes the authentication device 200 to perform the second face authentication. In a case where the second face authentication has succeeded, the second acquisition unit 115 instructs the payment terminal 400 to perform the payment processing, and acquires a payment time (second time) and a payment history of the user (Step S505).

Once the instruction for the payment processing is received, the payment terminal 400 performs the payment processing and transmits, as a response, a payment history that is a result of the payment to the advertisement evaluation device 100a. In Step S505, the second acquisition unit 115 acquires the payment time included in the payment history and the payment history received from the payment terminal 400 as the second time and the payment history. Note that the payment terminal 400 transmits the payment history to the advertisement evaluation device 100a together with the second captured image in a case of making payment without depending on the face authentication. Examples of a method of making payment without depending on the face authentication include a method of making payment by using a credit card and a method of making payment by using electronic money.

Next, the registration unit 116 registers, in the storage unit 120, the payment history acquired by the second acquisition unit 115 in Step S505 (Step S506). Next, the calculation unit 118 calculates the stay time of the user in the store X (Step S507). Note that, although FIG. 11 illustrates a case where Step S507 is performed after Step S506, Step S507 may be performed before Step S506 or may be performed in parallel with Step S506. Next, the evaluation unit 119 evaluates the advertising effectiveness of the advertisement information presented in Step S501 based on the payment history and the stay time (Step S508).

Step S503 will be described in detail with reference to FIG. 12. First, once the first captured image is acquired, the authentication control unit 117 extracts a face region or face feature information from the first captured image. Then, the authentication control unit 117 transmits a face authentication request including the extracted face region or face feature information to the authentication device 200 (Step S601). The authentication device 200 performs the first face authentication based on the received face region or face feature information, and transmits, as a response, an authentication result to the advertisement evaluation device 100a. The authentication control unit 117 receives the result indicating the success or failure of the first face authentication (Step S602).

In a case where the first face authentication has succeeded (Yes in Step S603), the first acquisition unit 113 acquires a time at which the first captured image is captured as the store entrance time of the user to the store X (Step S604). In a case where the first face authentication has failed (No in Step S603), the authentication control unit 117 transmits, as a response, the fact that the face authentication has failed to the first acquisition unit 113 (Step S605).

Step S505 will be described in detail with reference to FIG. 13. First, once the second captured image is acquired, the authentication control unit 117 extracts a face region or face feature information from the second captured image. Then, the authentication control unit 117 transmits a face authentication request including the extracted face region or face feature information to the authentication device 200 (Step S701). The authentication device 200 performs the second face authentication based on the received face region or face feature information, and transmits, as a response, an authentication result to the advertisement evaluation device 100a. The authentication control unit 117 receives the result indicating the success or failure of the second face authentication (Step S702).

In a case where the second face authentication has succeeded (Yes in Step S703), the second acquisition unit 115 instructs the payment terminal 400 to perform the payment processing (Step S704). Once the instruction for the payment processing is received, the payment terminal 400 performs the payment processing and transmits, as a response, a payment history that is a result of the payment to the advertisement evaluation device 100a. The second acquisition unit 115 acquires a payment time and the payment history included in the payment history received from the payment terminal 400 as the payment time (second time) and the payment history. In a case where the second face authentication has failed (No in Step S703), the authentication control unit 117 transmits, as a response, the fact that the face authentication has failed to the second acquisition unit 115 (Step S706).

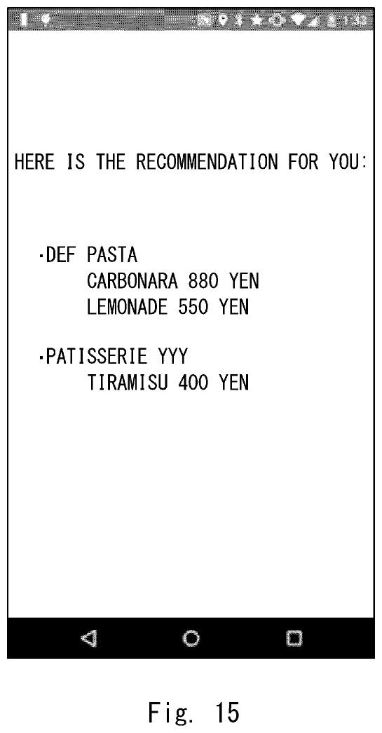

FIG. 15 is a view illustrating the advertisement information displayed on the display terminal. FIG. 14 illustrates a case where the advertisement information is displayed on the user terminal 1200. As illustrated in FIG. 14, the user terminal 1200 displays the advertisement information received in Step S501 on a screen. Note that, in Step S501, the presentation unit 111 may transmit the payment history of the user to the display terminal in addition to the advertisement information.

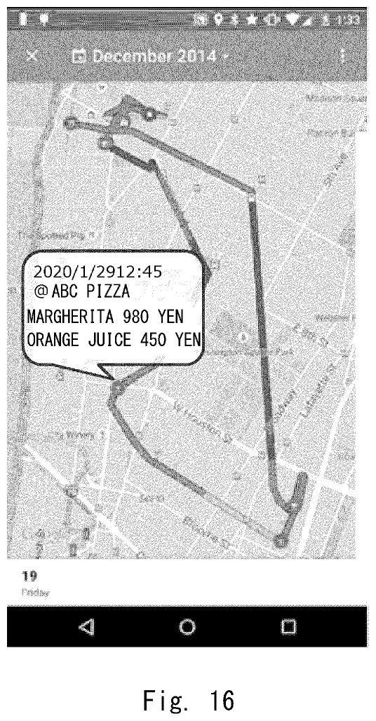

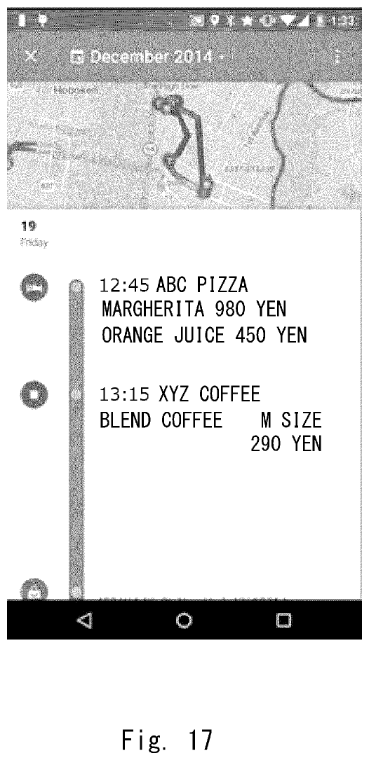

FIG. 16 is a view illustrating a map displayed as the payment history on the display terminal. As illustrated in FIG. 16, the user terminal 1200 may display the payment history of the user received in Step S501 on the map. Furthermore, FIG. 17 is a view illustrating the payment history displayed on the display terminal. As illustrated in FIG. 17, the user terminal may display the payment history received in Step S501 in time series.

FIGS. 16 and 17 illustrate a case where only the payment history of the user is displayed on the display terminal, but the advertisement information may be displayed in addition to the payment history on the display terminal. The advertisement information may include store information, an address of the store, route guidance from the current location of the user to the store, and the like. The route guidance may include a distance from the current location of the user to the store, a required time, and the like. Further, a plurality of pieces of advertisement information may be displayed on the display terminal. In a case where a plurality of pieces of advertisement information are displayed, details of each piece of advertisement information, route guidance, and the like may be simultaneously displayed. The user can examine the details of each piece of advertisement information, route guidance, and the like, and compare the pieces of advertisement information with each other.

Hereinafter, a specific example of the evaluation of the advertising effectiveness based on the payment history and the stay time will be described. Table 1 shows an example of the evaluation of the advertising effectiveness.

TABLE 1

| Stay time | Payment history | Advertising effectiveness |
|---|---|---|
| Less than 10 minutes | Exist | 5 |
| 10 minutes or more | Not exist | 4 |

The advertising effectiveness shown in Table 1 indicates that the larger the numerical value, the higher the effect. As illustrated in Table 1, in a case where the stay time is short (for example, five minutes) and a payment history exists, it is considered that the advertisement information presented to the user matches the preference and demand of the user. Therefore, in such a case, it is evaluated that the advertising effectiveness is high. In a case where the stay time is long (for example, 30 minutes) and a payment history exists, it is considered that the advertisement information presented to the user meets the demand of the user but slightly deviates from the preference. Therefore, in such a case, it is evaluated that the advertising effectiveness is slightly high.

As described above, since the advertisement evaluation device 100a performs the advertisement evaluation based on the payment history and the stay time, it is possible to accurately measure the effectiveness of the advertisement presented to the user. The display frequency of the advertisement information evaluated as having a low effectiveness may be reduced, and the display frequency of the advertisement information evaluated as having a high effectiveness may be increased according to a result of measuring the advertising effectiveness. As a result, a more effective advertisement can be presented to a user. In addition, the advertisement rates of the advertisement information evaluated as having a low effectiveness may be lowered, and the advertisement rates of the advertisement information evaluated has having a high effectiveness may be raised. As a result, it is possible to increase the degree of satisfaction of a client who bears the advertisement rates. Moreover, the advertisement evaluation device according to the present example embodiment can achieve effects similar to the effects described in the first to third example embodiments.

### Fourth Example Embodiment

A fourth example embodiment is a modification of the third example embodiment described above. The advertisement evaluation device 100a according to the third example embodiment acquires the store leaving time based on the payment history. On the other hand, in the fourth example embodiment, a store leaving time is acquired based on a captured image captured by an exit camera.

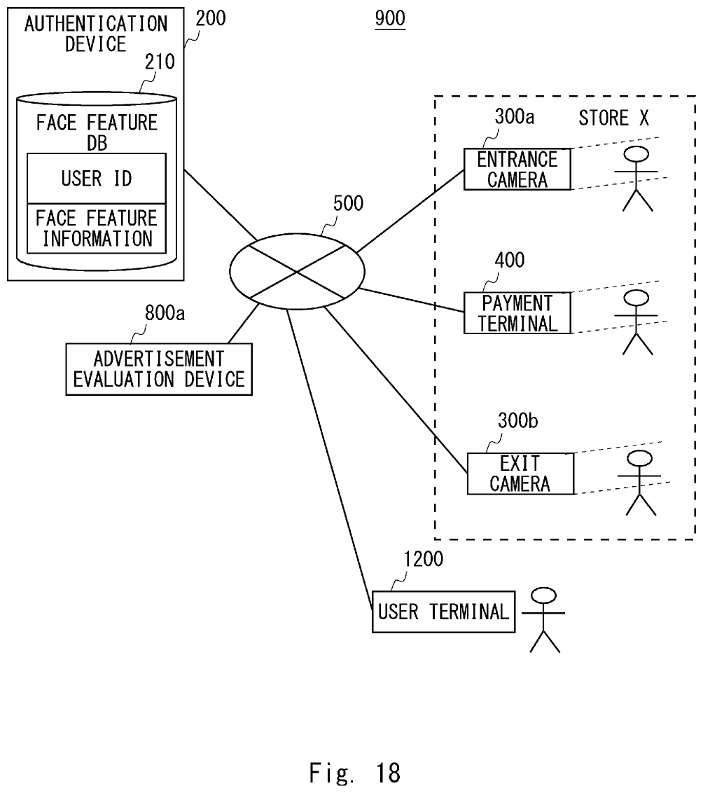

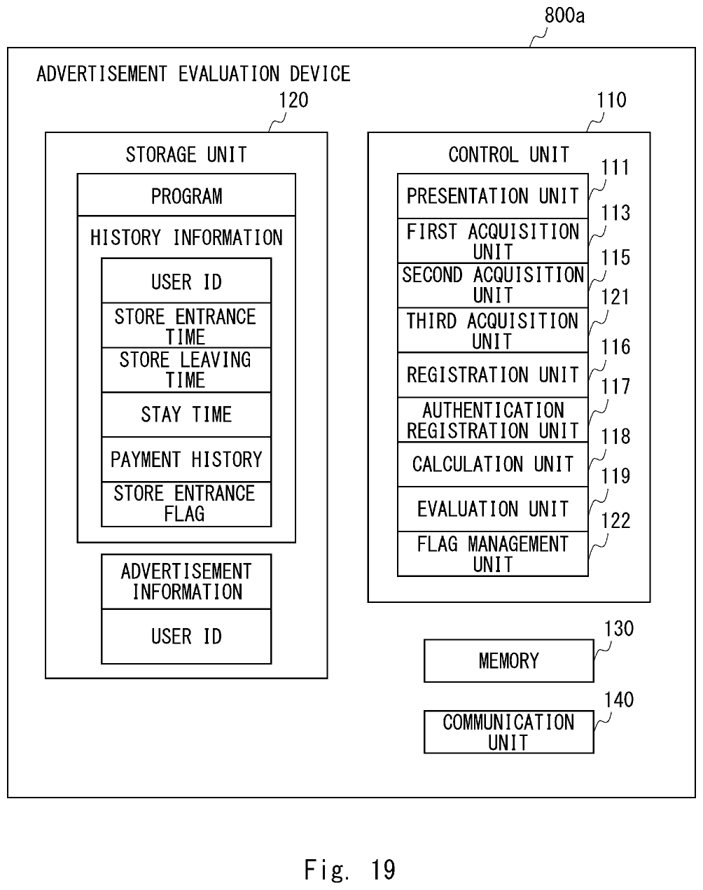

FIG. 18 is a block diagram illustrating a configuration of an advertisement evaluation system 900 according to the fourth example embodiment. In the advertisement evaluation system 900, the advertisement evaluation device 100a in the configuration of the advertisement evaluation system 700 illustrated in FIG. 5 is replaced with an advertisement evaluation device 800a, and an exit camera 300b is further included. Note that the exit camera 300b is an example of the imaging device. For each component included in the advertisement evaluation system 900, a description overlapping with that of the third example embodiment will be omitted as appropriate. FIG. 19 is a block diagram illustrating a configuration of the advertisement evaluation device according to the fourth example embodiment. The advertisement evaluation device 800a is different from the advertisement evaluation device 100a in that a third acquisition unit 121 and a flag management unit 122 are included. Since the other components are similar, a description thereof will be omitted as appropriate.

The exit camera 300b is, for example, a digital camera installed near an exit of a store X, a digital signage equipped with a camera, or a face authentication terminal. The exit camera 300b may be shared with the entrance camera 300a. Furthermore, the exit camera 300b may be a camera included in the payment terminal 400. The exit camera 300b captures a third captured image by imaging a user leaving the store X. The third captured image is an image captured when a predetermined user leaves the store, and includes a face region of the user. The exit camera 300b transmits the third captured image to the advertisement evaluation device 800a via the network 500.

Note that, in a case where the advertisement evaluation system 900 is installed in a facility having a plurality of floors, entrance/leaving and payment made by a user may be recorded for each floor. In this case, the entrance camera 300a is installed near an entrance of each floor. The entrance camera 300a captures the first captured image by imaging a user who has entered the floor. The exit camera 300b is installed near an exit of each floor. The exit of each floor is, for example, an entrance of an escalator, an entrance of an elevator, and an entrance of a staircase. The exit camera 300b captures the third captured image by imaging a user leaving the floor.

In the present example embodiment, the authentication device 200 performs third face authentication in addition to the first face authentication and the second face authentication. The third face authentication is performed in the procedure illustrated in FIG. 8 similarly to the first face authentication and the second face authentication. The third acquisition unit 121 acquires a third time as the second time in a case where the third face authentication has succeeded and the user does not make payment in the store X. The third time is a time at which a predetermined user has left the store, for example, a time at which the third captured image is captured. Once the third acquisition unit 121 acquires the third time, the registration unit 116 registers the fact that no payment has been made in the store as the payment history in the storage unit 120.

In the present example embodiment, the storage unit 120 includes a flag storage unit. The flag storage unit stores a store entrance flag of a user in association with a user ID. The store entrance flag is a flag for recording whether or not a user has entered the store X. The control unit 110 includes the flag management unit 122. The flag management unit 122 manages the store entrance flag. For example, in a case where the first face authentication has succeeded, the flag management unit 122 sets the store entrance flag of the user and registers the store entrance flag in flag storage means, and in a case where the second face authentication has succeeded, the flag management unit 122 resets the store entrance flag of the user and updates the flag storage means. Note that the implementation of the store entrance flag is not limited thereto.

In a case where the store entrance flag of the user is set in the flag storage unit, the third acquisition unit 121 considers that the user has made no payment in the store. In a case where the third face authentication has succeeded and the store entrance flag of the user is set in the flag storage unit, the flag management unit resets the store entrance flag and updates the flag storage unit. The calculation unit 118 calculates the stay time in a case where the store entrance flag of the user has been reset.

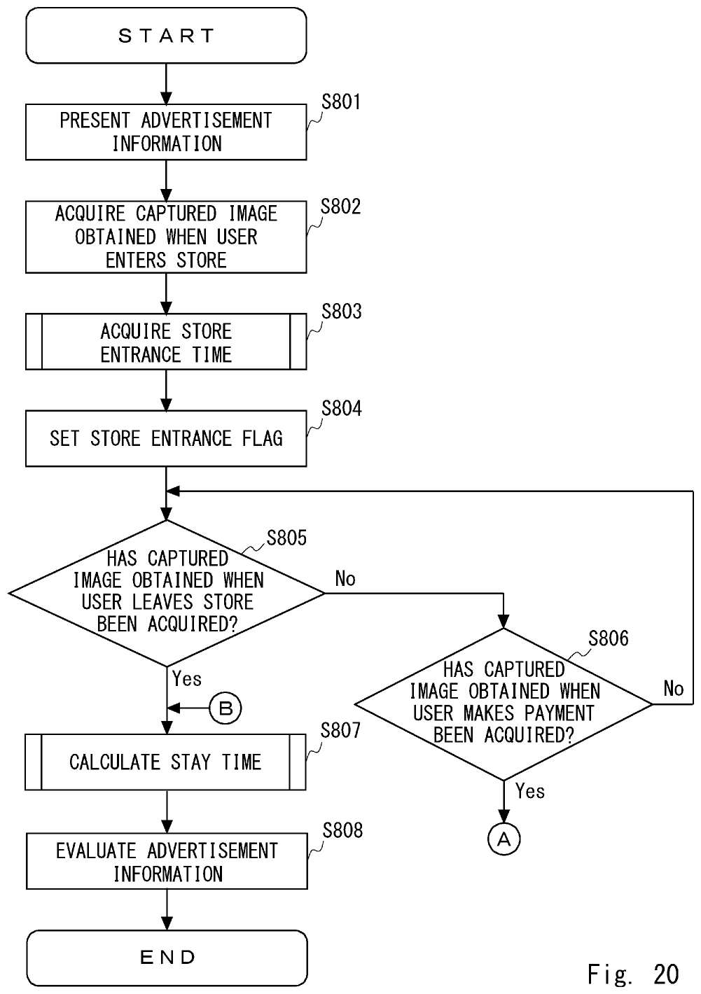

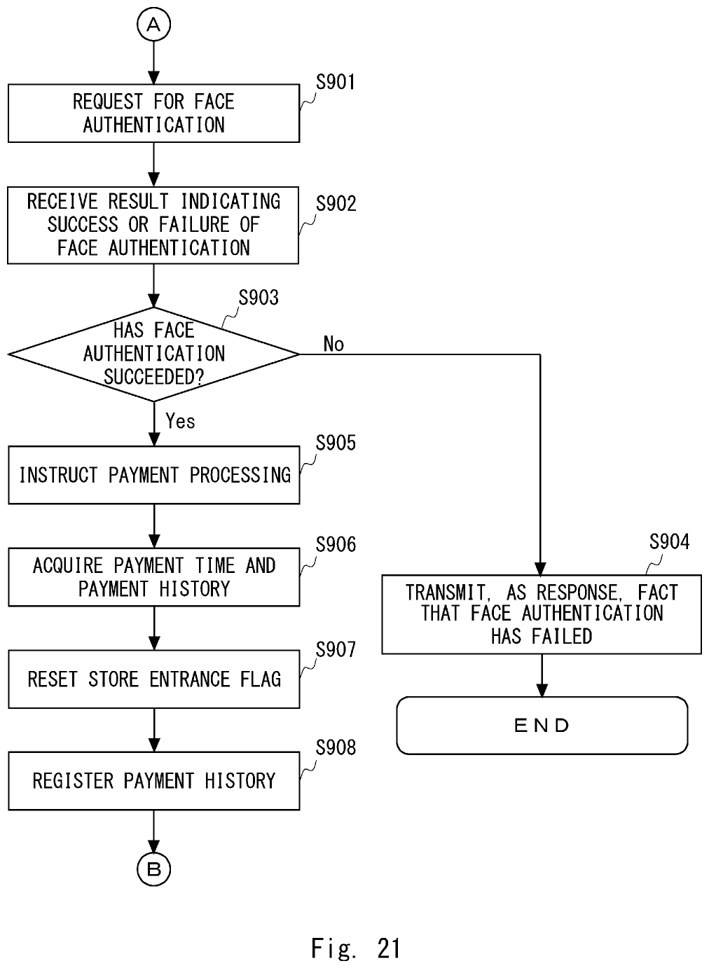

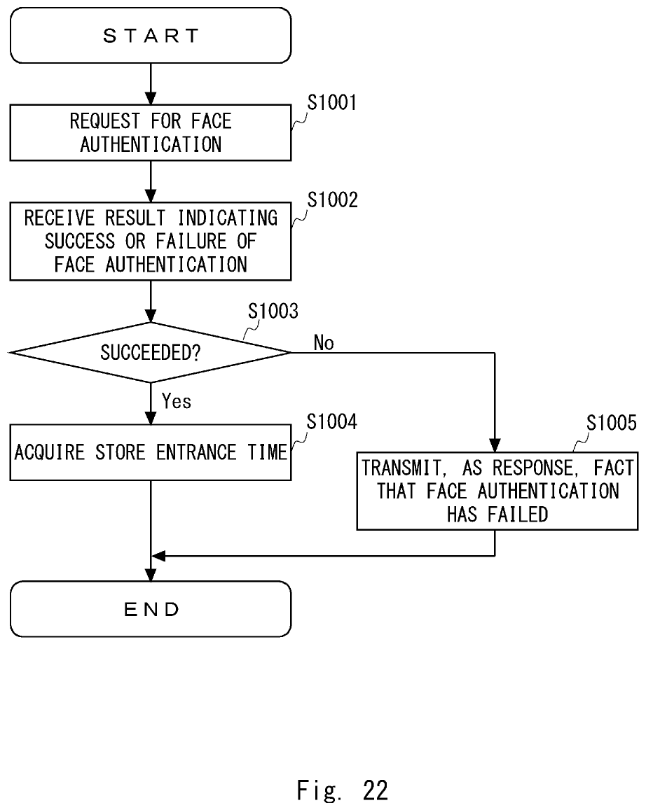

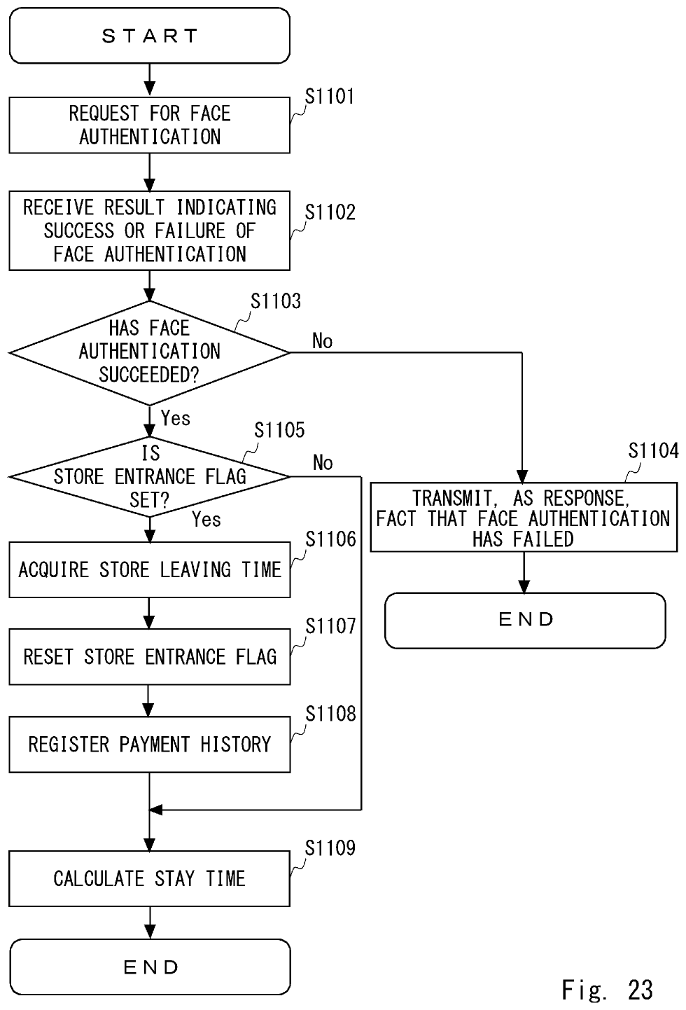

Next, an operation of the advertisement evaluation device 800a at the time of advertisement evaluation processing will be described with reference to FIGS. 20 to 23. FIGS. 20 and 21 are flowcharts illustrating a flow of the advertisement evaluation processing. FIG. 22 is a flowchart illustrating a flow of store entrance time acquisition processing. FIG. 23 is a flowchart illustrating a flow of stay time calculation processing.

First, the presentation unit 111 presents advertisement information associated with a user to the user by transmitting the advertisement information to a display terminal such as the user terminal 1200 (Step S801). Next, once the user enters the store X, the entrance camera 300a captures an image including a face of the user and transmits the captured image to the advertisement evaluation device 800a via the network 500. The authentication control unit 117 acquires the captured image (first captured image) obtained when the user enters the store by receiving the captured image from the entrance camera 300a (Step S802), and causes the authentication device 200 to perform the first face authentication. In a case where the first face authentication has succeeded, the first acquisition unit 113 acquires a store entrance time (first time) of the user (Step S803). Note that, in Step S803, the first acquisition unit 113 acquires an imaging time of the first captured image as the first time.

Next, the flag management unit 122 sets a store entrance flag of the user in the flag storage unit (Step S804). After entering the store X, the user leaves the store X after making payment in the store X or without making payment. At the time of payment, the payment terminal 400 captures an image including the face of the user and transmits the captured image to the advertisement evaluation device 800a via the network 500. At the time of leaving the store, the exit camera 300b captures an image including the face of the user, and transmits the captured image to the advertisement evaluation device 800a via the network 500. The captured image transmitted from the payment terminal 400 or the exit camera 300b is received by the authentication control unit 117.

In a case where the authentication control unit 117 has not acquired the captured image (third captured image) obtained when the user leaves the store (No in Step S805) and has not acquired the captured image (second captured image) obtained when the user makes payment (No in Step S806), it is considered that the user still stays in the store X. In a case where the authentication control unit 117 has acquired the third captured image (Yes in Step S805), the calculation unit 118 calculates a stay time of the user in the store X (Step S807). Next, the evaluation unit 119 evaluates the advertising effectiveness of the advertisement information presented in Step S501 based on the payment history and the stay time (Step S808).

An operation of the advertisement evaluation device 800a in a case where the authentication control unit 117 has not acquired the captured image (third captured image) obtained when the user leaves the store (No in Step S805) and has acquired the captured image (second captured image) obtained when the user makes payment (Yes in Step S806) will be described with reference to FIG. 21. First, once the second captured image is acquired, the authentication control unit 117 extracts a face region or face feature information from the second captured image. Then, the authentication control unit 117 transmits a face authentication request including the extracted face region or face feature information to the authentication device 200 (Step S901). The authentication device 200 performs the second face authentication based on the received face region or face feature information, and transmits, as a response, an authentication result to the advertisement evaluation device 800a. The authentication control unit 117 receives the result indicating the success or failure of the second face authentication (Step S902).

In a case where the second face authentication has failed (No in Step S903), the authentication control unit 117 transmits, as a response, the fact that the face authentication has failed to the second acquisition unit 115 (Step S904). In a case where the second face authentication has succeeded (Yes in Step S903), the second acquisition unit 115 instructs the payment terminal 400 to perform the payment processing (Step S905). Once the instruction for the payment processing is received, the payment terminal 400 performs the payment processing and transmits, as a response, a payment history that is a result of the payment to the advertisement evaluation device 100a. The second acquisition unit 115 acquires a payment time and the payment history included in the payment history received from the payment terminal 400 as the payment time (second time) and the payment history (Step S906).

Next, the flag management unit 122 resets the store entrance flag of the user (Step S907). Next, the registration unit 116 registers the payment history acquired in Step S906 in the storage unit 120 (Step S908). After Step S908, the calculation unit 118 calculates the stay time of the user in the store X (Step S806).

Step S803 will be described in detail with reference to FIG. 22. First, once the first captured image is acquired, the authentication control unit 117 extracts a face region or face feature information from the first captured image. Then, the authentication control unit 117 transmits a face authentication request including the extracted face region or face feature information to the authentication device 200 (Step S1001). The authentication device 200 performs the first face authentication based on the received face region or face feature information, and transmits, as a response, an authentication result to the advertisement evaluation device 800a. The authentication control unit 117 receives the result indicating the success or failure of the first face authentication (Step S1002).

In a case where the first face authentication has succeeded (Yes in Step S1003), the first acquisition unit 113 acquires a time at which the first captured image is captured as the store entrance time of the user to the store X (Step S1004). In a case where the first face authentication has failed (No in Step S1003), the authentication control unit 117 transmits, as a response, the fact that the face authentication has failed to the first acquisition unit 113 (Step S1005).

Step S807 will be described in detail with reference to FIG. 23. First, once the third captured image is acquired, the authentication control unit 117 extracts a face region or face feature information from the third captured image. Then, the authentication control unit 117 transmits a face authentication request including the extracted face region or face feature information to the authentication device 200 (Step S1101). The authentication device 200 performs the third face authentication based on the received face region or face feature information, and transmits, as a response, an authentication result to the advertisement evaluation device 800a. The authentication control unit 117 receives the result indicating the success or failure of the third face authentication (Step S1102).

In a case where the third face authentication has failed (No in Step S1103), the authentication control unit 117 transmits, as a response, the fact that the face authentication has failed to the third acquisition unit 121 (Step S1104). In a case where the third face authentication has succeeded (Yes in Step S1103), the flag management unit 122 checks whether or not the store entrance flag of the user is set (Step S1105). In a case where the store entrance flag is set (Yes in Step S1105), the third acquisition unit 121 acquires a time at which the third captured image is captured as a store leaving time of the user from the store X (Step S1106). Next, the flag management unit 122 resets the store entrance flag of the user and updates the flag storage unit (Step S1107). Next, the registration unit 116 registers the fact that no payment has been made in the store X as the payment history in the storage unit 120 (Step S1108). Note that, in Step S1108, information on the store that the user has entered and left is included in the payment history and registered in the storage unit 120.

Next, the calculation unit 118 calculates the stay time of the user in the store X (Step S1109). In a case where the store entrance flag is not set (No in Step S1105) and in a case where the payment history is registered in the storage unit 120 (Step S1108), the calculation unit 118 calculates the stay time (Step S1109).

Hereinafter, a specific example of the evaluation of the advertising effectiveness based on the payment history and the stay time will be described. Table 2 shows an example of the evaluation of the advertising effectiveness.

TABLE 2

| Stay time | Payment history | Advertising effectiveness |
|---|---|---|
| 10 minutes or more | Not exist | 2 |
| Less than 10 minutes | Not exist | 1 |
| 0 minutes (no visit) | Not exist | 0 |

In a case where the stay time is long (for example, 60 minutes) and no payment history exists, it is considered that the advertisement information presented to the user meets the preference of the user but deviates from the demand. Therefore, in such a case, it is evaluated that the advertising effectiveness is slightly low. In a case where the stay time is short (for example, five minutes) and no payment history exists, it is considered that the advertisement information presented to the user deviates from the preference of the user and does not meet the demand. Therefore, in such a case, it is evaluated that the advertising effectiveness is low. In a case where the user does not visit the store, it is considered that the advertisement information presented to the user does not match the preference and demand of the user. Therefore, in such a case, it is evaluated that the advertising effectiveness is very low.

Since the advertisement evaluation device according to the present example embodiment can record the store leaving time even in a case where the user makes no payment in the store X, the stay time can be comprehensively calculated. Moreover, the advertisement evaluation device according to the present example embodiment can achieve effects similar to the effects described in the first to third example embodiments.

Note that, although the hardware configuration has been described in the above-described example embodiments, the present disclosure is not limited thereto. According to the present disclosure, arbitrary processing can also be implemented by causing a CPU to execute a computer program.

In the above example, the program may be stored using various types of non-transitory computer-readable media and supplied to a computer. The non-transitory computer-readable media include various types of tangible storage media. Examples of the non-transitory computer-readable medium include a magnetic recording medium (for example, a flexible disk, a magnetic tape, or a hard disk drive), an optical magnetic recording medium (for example, a magneto-optical disk), a compact disc-read only memory (CD-ROM), a CD-R, a CD-R/W, a digital versatile disc (DVD), and a semiconductor memory such as a mask ROM, a programmable ROM (PROM), an erasable PROM (EPROM), a flash ROM, or a random access memory (RAM). In addition, the program may be supplied to the computer by various types of transitory computer-readable media. Examples of the transitory computer-readable medium include an electric signal, an optical signal, and electromagnetic waves. The transitory computer-readable medium can provide the program to the computer via a wired communication line such as electric wires and optical fibers or a wireless communication line.

Note that the present disclosure is not limited to the above example embodiments, and can be appropriately changed without departing from the gist. Furthermore, the present disclosure may be implemented by appropriately combining the respective example embodiments.

The whole or part of the example embodiments disclosed above can be described as, but not limited to, the following Supplementary Notes.

(Supplementary Note A1)

An advertisement evaluation device including:

a first acquisition unit configured to acquire a first time that is an entrance time to a predetermined store in a case where first face authentication using an authentication device that stores face feature information of the user in advance has succeeded for a first captured image obtained by imaging the user when the user enters the store;

a second acquisition unit configured to acquire a second time that is a payment time in a case where second face authentication using the authentication device has succeeded for a second captured image obtained by imaging the user when the user makes payment in the store;

a registration unit configured to register a payment history based on the payment in association with the user in a case where the second face authentication has succeeded;

a calculation unit configured to calculate a stay time of the user in the store based on a difference between the first time and the second time; and an evaluation unit configured to evaluate an advertising effectiveness of advertisement information presented to the user based on the payment history and the stay time.

(Supplementary Note A2)

The advertisement evaluation device according to Supplementary Note A1, in which in a case where a payment amount of each of a plurality of the payment histories is within a predetermined range, the evaluation unit evaluates the advertising effectiveness based on a difference between the stay times corresponding to the respective payment histories.

(Supplementary Note A3)

The advertisement evaluation device according to Supplementary Note A1 or A2, in which in a case where the stay time corresponding to each of a plurality of the payment histories is within a predetermined range, the evaluation unit evaluates the advertising effectiveness based on a difference between payment amounts in the respective payment histories.

(Supplementary Note A4)

The advertisement evaluation device according to any one of Supplementary Notes A1 to A3, in which the evaluation unit evaluates the advertising effectiveness based on a difference between payment amounts in a plurality of the payment histories.

(Supplementary Note A5)

The advertisement evaluation device according to any one of Supplementary Notes A1 to A4, further including:

a storage unit configured to store the user and the advertisement information of the store in association with each other; and

a presentation unit configured to present the advertisement information associated with the user to the user.

(Supplementary Note A6)

The advertisement evaluation device according to any one of Supplementary Notes A1 to A5, further including a third acquisition unit configured to acquire, as the second time, a third time that is a leaving time from the store in a case where third face authentication using the authentication device has succeeded for a third captured image obtained by imaging the user when the user leaves the store, and the user has made no purchase in the store, in which

the registration unit registers, as the payment history, a fact that no purchase has been made in the store in the storage unit in a case where the third time has been acquired, and

the evaluation unit evaluates the advertising effectiveness to be lower in a case where the payment history indicates that no purchase has been made than in a case where the payment history indicates that payment has been made.

(Supplementary Note A7)

The advertisement evaluation device according to Supplementary Note A6, in which in a case where the payment history for a current stay associated with the user does not exist in the storage unit, the third acquisition unit considers that the user has made no payment in the store.

(Supplementary Note A8)

The advertisement evaluation device according to Supplementary Note A6, further including:

a flag storage unit configured to store a store entrance flag of the user; and

a flag management unit configured to set the store entrance flag of the user and registering the store entrance flag in the flag storage unit in a case where the first face authentication has succeeded, and resetting the store entrance flag of the user and updating the flag storage unit in a case where the second face authentication has succeeded, in which

in a case where the store entrance flag of the user is set in the flag storage unit, the third acquisition unit considers that the user has made no payment in the store,

the flag management unit resets the store entrance flag and updates the flag storage unit in a case where the third face authentication has succeeded and the store entrance flag of the user is set in the flag storage unit, and

the calculation unit calculates the stay time in a case where the store entrance flag of the user has been reset.

(Supplementary Note B1)

An advertisement evaluation device including:

a calculation unit configured to calculate a stay time of a user in a store; and

an evaluation unit configured to evaluate an advertising effectiveness of advertisement information presented to the user based on the stay time.

(Supplementary Note C1)

An advertisement evaluation system including:

an imaging device configured to capture an image including a face region of a predetermined user;

a payment terminal configured to perform payment for the user;

an advertisement evaluation device configured to be communicable with the imaging device and the payment terminal; and

an authentication device configured to store face feature information of the user and be communicable with the advertisement evaluation device,

in which the advertisement evaluation device includes:

a first acquisition unit configured to acquire a first time that is an entrance time to a predetermined store in a case where first face authentication using an authentication device that stores face feature information of the user in advance has succeeded for a first captured image obtained by imaging the user when the user enters the store;

a second acquisition unit configured to acquire a second time that is a payment time in a case where second face authentication using the authentication device has succeeded for a second captured image obtained by imaging the user when the user makes payment in the store;

a registration unit configured to register a payment history based on the payment in association with the user in a case where the second face authentication has succeeded;

a calculation unit configured to calculate a stay time of the user in the store based on a difference between the first time and the second time; and

an evaluation unit configured to evaluate an advertising effectiveness of advertisement information presented to the user based on the payment history and the stay time.

(Supplementary Note C2)

The advertisement evaluation system according to Supplementary Note C1, in which in a case where a payment amount of each of a plurality of the payment histories is within a predetermined range, the evaluation unit evaluates the advertising effectiveness based on a difference between the stay times corresponding to the respective payment histories.

(Supplementary Note D1)

An advertisement evaluation method performed by a computer, the advertisement evaluation method including:

acquiring a first time that is an entrance time to a predetermined store in a case where first face authentication using an authentication device that stores face feature information of a predetermined user in advance has succeeded for a first captured image obtained by imaging the user when the user enters the store;

acquiring a second time that is a payment time in a case where second face authentication using the authentication device has succeeded for a second captured image obtained by imaging the user when the user makes payment in the store;

registering a payment history based on the payment in association with the user in a case where the second face authentication has succeeded;

calculating a stay time of the user in the store based on a difference between the first time and the second time; and

evaluating an advertising effectiveness of advertisement information presented to the user based on the payment history and the stay time.

(Supplementary Note E1)

A non-transitory computer-readable medium storing an advertisement evaluation program for causing a computer to perform:

acquiring a first time that is an entrance time to a predetermined store in a case where first face authentication using an authentication device that stores face feature information of a predetermined user in advance has succeeded for a first captured image obtained by imaging the user when the user enters the store;

acquiring a second time that is a payment time in a case where second face authentication using the authentication device has succeeded for a second captured image obtained by imaging the user when the user makes payment in the store;

registering a payment history based on the payment in association with the user in a case where the second face authentication has succeeded;

calculating a stay time of the user in the store based on a difference between the first time and the second time; and

evaluating an advertising effectiveness of advertisement information presented to the user based on the payment history and the stay time.

(Supplementary Note F1)

An advertisement evaluation device including:

a first authentication unit configured to perform first face authentication by using face feature information of a predetermined user stored in advance for a first captured image obtained by imaging the user when the user enters a predetermined store;

a first acquisition unit configured to acquire a first time that is an entrance time to the store in a case where the first face authentication has succeeded for the first captured image obtained by imaging the user when the user enters the store;

a second authentication unit configured to perform second face authentication by using the face feature information of the user for a second captured image obtained by imaging the user when the user makes payment in the store;

a second acquisition unit configured to acquire a second time that is a payment time in a case where the second face authentication has succeeded for the second captured image obtained by imaging the user when the user makes the payment in the store;

a registration unit configured to register a payment history based on the payment in association with the user in a case where the second face authentication has succeeded;

a calculation unit configured to calculate a stay time of the user in the store based on a difference between the first time and the second time; and

an evaluation unit configured to evaluate an advertising effectiveness of advertisement information presented to the user based on the payment history and the stay time.

(Supplementary Note F2)

The advertisement evaluation device according to Supplementary Note F1, in which in a case where a payment amount of each of a plurality of the payment histories is within a predetermined range, the evaluation unit evaluates the advertising effectiveness based on a difference between the stay times corresponding to the respective payment histories.

(Supplementary Note G1)

An advertisement evaluation method performed by a computer, the advertisement evaluation method including:

performing first face authentication by using face feature information of a predetermined user stored in advance for a first captured image obtained by imaging the user when the user enters a predetermined store;

acquiring a first time that is an entrance time to the store in a case where the first face authentication has succeeded for the first captured image obtained by imaging the user when the user enters the store;

performing second face authentication by using the face feature information of the user for a second captured image obtained by imaging the user when the user makes payment in the store;

acquiring a second time that is a payment time in a case where the second face authentication has succeeded for the second captured image obtained by imaging the user when the user makes the payment in the store;

registering a payment history based on the payment in association with the user in a case where the second face authentication has succeeded;

calculating a stay time of the user in the store based on a difference between the first time and the second time; and

evaluating an advertising effectiveness of advertisement information presented to the user based on the payment history and the stay time.

(Supplementary Note H1)

A non-transitory computer-readable medium storing an advertisement evaluation program that causes a computer to perform:

performing first face authentication by using face feature information of a predetermined user stored in advance for a first captured image obtained by imaging the user when the user enters a predetermined store;

acquiring a first time that is an entrance time to the store in a case where the first face authentication has succeeded for the first captured image obtained by imaging the user when the user enters the store;

performing second face authentication by using the face feature information of the user for a second captured image obtained by imaging the user when the user makes payment in the store;

acquiring a second time that is a payment time in a case where the second face authentication has succeeded for the second captured image obtained by imaging the user when the user makes the payment in the store;

registering a payment history based on the payment in association with the user in a case where the second face authentication has succeeded;

calculating a stay time of the user in the store based on a difference between the first time and the second time; and

evaluating an advertising effectiveness of advertisement information presented to the user based on the payment history and the stay time.

Although the present invention has been described with reference to the example embodiments (and examples), the present invention is not limited to the above example embodiments (and examples). Various modifications that can be understood by those skilled in the art can be made to the configuration and details of the present invention within the scope of the present invention.

### REFERENCE SIGNS LIST

100, 100a, 600800a ADVERTISEMENT EVALUATION DEVICE
700, 900 ADVERTISEMENT EVALUATION SYSTEM
110 CONTROL UNIT
111 PRESENTATION UNIT
112 FIRST AUTHENTICATION UNIT
113 FIRST ACQUISITION UNIT
114 SECOND AUTHENTICATION UNIT
115 SECOND ACQUISITION UNIT
116 REGISTRATION UNIT
117 AUTHENTICATION CONTROL UNIT
118 CALCULATION UNIT
119 EVALUATION UNIT
121 THIRD ACQUISITION UNIT
122 FLAG MANAGEMENT UNIT
120 STORAGE UNIT
130 MEMORY
140 COMMUNICATION UNIT
200 AUTHENTICATION DEVICE
210 FACE FEATURE DB
220 FACE DETECTION UNIT
230 FEATURE POINT EXTRACTION UNIT
240 REGISTRATION UNIT
250 AUTHENTICATION UNIT
300a ENTRANCE CAMERA
300b EXIT CAMERA
400 PAYMENT TERMINAL
410 CAMERA
420 STORAGE UNIT
430 COMMUNICATION UNIT
440 DISPLAY UNIT
450 CONTROL UNIT
452 IMAGING UNIT
453 REGISTRATION UNIT
454 AUTHENTICATION UNIT
455 PAYMENT UNIT
500 NETWORK
1200 USER TERMINAL
1210 CAMERA
1220 STORAGE UNIT
1230 COMMUNICATION UNIT
1240 DISPLAY UNIT
1250 CONTROL UNIT
1253 FACE REGISTRATION UNIT
1254 ADVERTISEMENT REQUESTING UNIT

What is claimed is:

1. An advertisement evaluation device comprising:
at least one memory acquiring storing instructions and
at least one processor configured to execute the instructions to;
acquire a first time that is an entrance time to a predetermined store in a case where first face authentication using an authentication device that stores face feature information of the user in advance has succeeded for a first captured image obtained by imaging the user when the user enters the store;
acquire a second time that is a payment time in a case where second face authentication using the authentication device has succeeded for a second captured image obtained by imaging the user when the user makes payment in the store;
register a payment history based on the payment in association with the user in a case where the second face authentication has succeeded;
calculate a stay time of the user in the store based on a difference between the first time and the second time; and
evaluate an advertising effectiveness of advertisement information presented to the user based on the payment history and the stay time.

2. The advertisement evaluation device according to claim 1, wherein the at least one processor configured to execute the instructions to, in a case where a payment amount of each of a plurality of the payment histories is within a predetermined range, evaluate the advertising effectiveness based on a difference between the stay times corresponding to the respective payment histories.

3. The advertisement evaluation device according to claim 1, wherein the at least one processor configured to execute the instructions to, in a case where the stay time corresponding to each of a plurality of the payment histories is within a predetermined range, evaluate the advertising effectiveness based on a difference between payment amounts in the respective payment histories.

4. The advertisement evaluation device according to claim 1, wherein the at least one processor configured to execute the instructions to evaluate the advertising effectiveness based on a difference between payment amounts in a plurality of the payment histories.

5. The advertisement evaluation device according to claim 1, wherein,
the at least one memory is configured to store the user and the advertisement information of the store in association with each other; and
the at least one processor is further configured to execute the instructions to present the advertisement information associated with the user to the user.

6. The advertisement evaluation device according to claim 1, the at least one processor is further configured to execute the instructions to acquire, as the second time, a third time that is a leaving time from the store in a case where third face authentication using the authentication device has succeeded for a third captured image obtained by imaging the user when the user leaves the store, and the user has made no purchase in the store, wherein
register, as the payment history, a fact that no purchase has been made in the store in the at least one memory in a case where the third time has been acquired, and
evaluate the advertising effectiveness to be lower in a case where the payment history indicates that no purchase has been made than in a case where the payment history indicates that payment has been made.

7. The advertisement evaluation device according to claim 6, wherein in a case where the payment history for a current stay associated with the user does not exist in the at least one memory, the at least one processor configured to execute the instructions to consider that the user has made no payment in the store.

8. The advertisement evaluation device according to claim 6, wherein,
the at least one memory is configured to store a store entrance flag of the user; and
the at least one processor is further configured to execute the instructions to:
set the store entrance flag of the user and registering the store entrance flag in the at least one memory in a case where the first face authentication has succeeded, and reset the store entrance flag of the user and updating the at least one memory in a case where the second face authentication has succeeded, wherein
in a case where the store entrance flag of the user is set in the at least one memory, consider that the user has made no payment in the store,
reset the store entrance flag and updates the at least one memory in a case where the third face authentication has succeeded and the store entrance flag of the user is set in the at least one memory, and
calculate the stay time in a case where the store entrance flag of the user has been reset.

9. An advertisement evaluation device comprising:
at least one memory acquiring storing instructions and
at least one processor configured to execute the instructions to;
calculate a stay time of a user in a store; and
evaluate an advertising effectiveness of advertisement information presented to the user based on the stay time.

10. An advertisement evaluation system comprising:
an imaging device configured to capture an image including a face region of a predetermined user;
a payment terminal configured to perform payment for the user;
an advertisement evaluation device configured to be communicable with the imaging device and the payment terminal; and
an authentication device configured to store face feature information of the user and be communicable with the advertisement evaluation device,
wherein the advertisement evaluation device includes:
first acquisition means for acquiring a first time that is an entrance time to a predetermined store in a case where first face authentication using an authentication device that stores face feature information of the user in advance has succeeded for a first captured image obtained by imaging the user when the user enters the store;
second acquisition means for acquiring a second time that is a payment time in a case where second face authentication using the authentication device has succeeded for a second captured image obtained by imaging the user when the user makes payment in the store;
registration means for registering a payment history based on the payment in association with the user in a case where the second face authentication has succeeded;
calculation means for calculating a stay time of the user in the store based on a difference between the first time and the second time; and
evaluation means for evaluating an advertising effectiveness of advertisement information presented to the user based on the payment history and the stay time.

11. The advertisement evaluation system according to claim 10, wherein in a case where a payment amount of each of a plurality of the payment histories is within a predetermined range, the evaluation means evaluates the advertising effectiveness based on a difference between the stay times corresponding to the respective payment histories.

12. An advertisement evaluation method performed by a computer, the advertisement evaluation method comprising:
acquiring a first time that is an entrance time to a predetermined store in a case where first face authentication using an authentication device that stores face feature information of a predetermined user in advance has succeeded for a first captured image obtained by imaging the user when the user enters the store;
acquiring a second time that is a payment time in a case where second face authentication using the authentication device has succeeded for a second captured image obtained by imaging the user when the user makes payment in the store;
registering a payment history based on the payment in association with the user in a case where the second face authentication has succeeded;
calculating a stay time of the user in the store based on a difference between the first time and the second time; and
evaluating an advertising effectiveness of advertisement information presented to the user based on the payment history and the stay time.

13. A non-transitory computer-readable medium storing an advertisement evaluation program for causing a computer to perform:
acquiring a first time that is an entrance time to a predetermined store in a case where first face authentication using an authentication device that stores face feature information of a predetermined user in advance has succeeded for a first captured image obtained by imaging the user when the user enters the store;
acquiring a second time that is a payment time in a case where second face authentication using the authentication device has succeeded for a second captured image obtained by imaging the user when the user makes payment in the store;
registering a payment history based on the payment in association with the user in a case where the second face authentication has succeeded;
calculating a stay time of the user in the store based on a difference between the first time and the second time; and
evaluating an advertising effectiveness of advertisement information presented to the user based on the payment history and the stay time.

14. An advertisement evaluation device comprising:
at least one memory acquiring storing instructions and
at least one processor configured to execute the instructions to;
perform first face authentication by using face feature information of a predetermined user stored in advance for a first captured image obtained by imaging the user when the user enters a predetermined store;
acquire a first time that is an entrance time to the store in a case where the first face authentication has succeeded for the first captured image obtained by imaging the user when the user enters the store;
perform second face authentication by using the face feature information of the user for a second captured image obtained by imaging the user when the user makes payment in the store;
acquire a second time that is a payment time in a case where the second face authentication has succeeded for the second captured image obtained by imaging the user when the user makes the payment in the store;
register a payment history based on the payment in association with the user in a case where the second face authentication has succeeded;
calculate a stay time of the user in the store based on a difference between the first time and the second time; and
evaluate an advertising effectiveness of advertisement information presented to the user based on the payment history and the stay time.

15. The advertisement evaluation device according to claim 14, wherein in a case where a payment amount of each of a plurality of the payment histories is within a predetermined range, at least one processor configured to execute the instructions to evaluate the advertising effectiveness based on a difference between the stay times corresponding to the respective payment histories.

16. An advertisement evaluation method performed by a computer, the advertisement evaluation method comprising:
performing first face authentication by using face feature information of a predetermined user stored in advance for a first captured image obtained by imaging the user when the user enters a predetermined store;
acquiring a first time that is an entrance time to the store in a case where the first face authentication has succeeded for the first captured image obtained by imaging the user when the user enters the store;
performing second face authentication by using the face feature information of the user for a second captured image obtained by imaging the user when the user makes payment in the store;
acquiring a second time that is a payment time in a case where the second face authentication has succeeded for the second captured image obtained by imaging the user when the user makes the payment in the store;
registering a payment history based on the payment in association with the user in a case where the second face authentication has succeeded;
calculating a stay time of the user in the store based on a difference between the first time and the second time; and
evaluating an advertising effectiveness of advertisement information presented to the user based on the payment history and the stay time.

17. A non-transitory computer-readable medium storing an advertisement evaluation program that causes a computer to perform:
performing first face authentication by using face feature information of a predetermined user stored in advance for a first captured image obtained by imaging the user when the user enters a predetermined store;
acquiring a first time that is an entrance time to the store in a case where the first face authentication has succeeded for the first captured image obtained by imaging the user when the user enters the store;
performing second face authentication by using the face feature information of the user for a second captured image obtained by imaging the user when the user makes payment in the store;
acquiring a second time that is a payment time in a case where the second face authentication has succeeded for the second captured image obtained by imaging the user when the user makes the payment in the store;
registering a payment history based on the payment in association with the user in a case where the second face authentication has succeeded;
calculating a stay time of the user in the store based on a difference between the first time and the second time; and
evaluating an advertising effectiveness of advertisement information presented to the user based on the payment history and the stay time.
